(19) United States
(12) Patent Application Publication
(10) Pub. No.: US 2025/0110434 A1
(43) Pub. Date: Apr. 3, 2025

(54) FIXING DEVICE AND IMAGE FORMING SYSTEM USING FIXING DEVICE

(71) Applicant: FUJIFILM Business Innovation Corp., Tokyo (JP)

(72) Inventor: Seigo SHINOZAKI, Kanagawa (JP)

(73) Assignee: FUJIFILM Business Innovation Corp., Tokyo (JP)

(21) Appl. No.: 18/582,993

(22) Filed: Feb. 21, 2024

(30) Foreign Application Priority Data
Sep. 28, 2023 (JP) 2023-168651

(51) Int. Cl. G03G 15/20

(52) U.S. Cl. CPC G03G 15/2064; G03G 15/2053; G03G 2215/2045

(57) ABSTRACT

A fixing device that heats and pressurizes a medium on which an unfixed image is held to fix the unfixed image includes a heating fixing part that includes a heating source, a belt-like transport fixing part that is stretched and rotatably provided around the heating fixing part and is in contact with an image surface of the medium to transport the medium, a pressure fixing part that is disposed to face the heating fixing part with the transport fixing part interposed therebetween and is pressurized to form a fixing region between the heating fixing part and the pressure fixing part, a drive unit that drives the transport fixing part to rotate the transport fixing part with a driving force generated from a drive source, and an operation unit that is operated to manually rotate the transport fixing part in a state where the drive unit is not used.

### CROSS-REFERENCE TO RELATED APPLICATIONS

This application is based on and claims priority under 35 USC 119 from Japanese Patent Application No. 2023-168651 filed Sep. 28, 2023.

### BACKGROUND

### (i) Technical Field

The present invention relates to a fixing device and an image forming system using the fixing device.

### (ii) Related Art

For example, devices disclosed in JP2007-163787A (Best Mode for Carrying Out the Invention, FIG. 4), JP1996-95417A (Examples, FIG. 1), and JP1999-119583A (Exemplary embodiment of the Invention, FIG. 3) have already been known as a fixing device or an image forming apparatus in the related art.

JP2007-163787A (Best Mode for Carrying Out the Invention, FIG. 4) discloses a fixing device including a heating member that includes a heating source, a pressure member that is disposed to face the heating member and forms a fixing nip region between the heating member and the pressure member, a belt member that is stretched and circulatably provided around the heating member and is in contact with a toner image surface of a recording material to be capable of transporting the recording material, and a belt drive unit that temporarily stops or decelerates the belt member after a rear end of the recording material passes through the fixing nip region and returns the belt member to an original state before a front end of a subsequent recording material reaches the fixing nip region.

JP1996-95417A (Examples, FIG. 1) discloses an image forming apparatus in which a knob for removing a jam is elastically supported to slide or oscillate in conjunction with the opening and closing of a front door and which includes a unit engaging or disengaging a drive device of an apparatus body with or from an interlocking device of a fixing device depending on the slide or oscillation of the knob.

JP1999-119583A (Exemplary embodiment of the Invention, FIG. 3) discloses an image forming apparatus including a drive contact/separation mechanism. The drive contact/separation mechanism includes a sheet transport unit that transmits drive via a drive transmission gear, releases the drive connection of the drive transmission gear using the weight of the drive transmission gear in a case where an opening/closing member is opened, and returns the drive transmission gear to a drive connection position in a case where the opening/closing member is closed.

### SUMMARY

Aspects of non-limiting embodiments of the present disclosure relate to a heating and pressurizing type fixing device which includes a belt-like transport fixing part and from which a medium on the transport fixing part can be manually discharged even though a medium jam occurs on the transport fixing part, and an image forming system using the fixing device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device that heats and pressurizes a medium on which an unfixed image is held to fix the unfixed image. The fixing device includes a heating fixing part that includes a heating source, a belt-like transport fixing part that is stretched and rotatably provided around the heating fixing part and is in contact with an image surface of the medium to transport the medium, a pressure fixing part that is disposed to face the heating fixing part with the transport fixing part interposed therebetween and is pressurized to form a fixing region between the heating fixing part and the pressure fixing part, a drive unit that drives the transport fixing part to rotate the transport fixing part with a driving force generated from a drive source, and an operation unit that is operated to manually rotate the transport fixing part in a state where the drive unit is not used.

### BRIEF DESCRIPTION OF THE DRAWINGS

Exemplary embodiment(s) of the present invention will be described in detail based on the following figures, wherein:

FIG. 1A is a diagram showing an overview of an exemplary embodiment of an image forming system that includes a fixing device to which the present invention is applied, and FIG. 1B is a diagram viewed in a direction of an arrow B of FIG. 1A;

FIG. 2 is a diagram showing the overall configuration of an image forming system according to a first exemplary embodiment;

FIG. 3 is a diagram showing the overall configuration of a second fixing unit according to a first exemplary embodiment;

FIG. 4 is a diagram viewed in a direction of an arrow IV of FIG. 3;

FIG. 5A is a diagram showing a dedicated sheet for a photographic image as an example of a medium, FIG. 5B is a diagram showing a state where a toner image is fixed to a dedicated sheet, and FIG. 5C is a diagram showing a state where a toner image is fixed to plain paper as an example of a medium;

FIG. 6 is a diagram showing an example of a support frame of the second fixing unit;

FIG. 7 is a diagram showing a configuration example of a manual operation mechanism of the second fixing unit;

FIG. 8 is a perspective view showing the detail of the manual operation mechanism shown in FIG. 7;

FIG. 9 is a diagram showing an arrangement relationship of a rotating operation handle of the manual operation mechanism;

FIG. 10 is a perspective view showing major parts of a manual operation mechanism of a second fixing unit according to a second exemplary embodiment;

FIG. 11 is a diagram showing a state of the manual operation mechanism in a case where a rotating operation handle is not used in the second exemplary embodiment;

FIG. 12 is a diagram showing an example of an operation of the manual operation mechanism in a case where the rotating operation handle is used in the second exemplary embodiment;

FIG. 13 is a diagram showing a modification example of a periphery of the manual operation mechanism according to the second exemplary embodiment;

FIG. 14 is a perspective view showing major parts of a manual operation mechanism of a second fixing unit according to a third exemplary embodiment;

FIG. 15 is a diagram showing a state of the manual operation mechanism in a case where a rotating operation handle is not used in the third exemplary embodiment;

FIG. 16 is a diagram showing an example of an operation of the manual operation mechanism in a case where the rotating operation handle is used in a normal rotation direction in the third exemplary embodiment;

FIG. 17 is a diagram showing an example of an operation of the manual operation mechanism in a case where the rotating operation handle is used in a reverse rotation direction in the third exemplary embodiment;

FIG. 18 is a perspective view showing major parts of a manual operation mechanism of a second fixing unit according to a fourth exemplary embodiment;

FIG. 19 is a diagram showing a drive transmission system of the manual operation mechanism shown in FIG. 18 in a plan view;

FIG. 20 is a diagram showing major parts of a manual operation mechanism of a second fixing unit according to a fifth exemplary embodiment; and

FIG. 21 is a diagram showing an example of an operation of the manual operation mechanism in a case where a rotating operation handle is used in the fifth exemplary embodiment.

### DETAILED DESCRIPTION

### Overview of Exemplary Embodiment

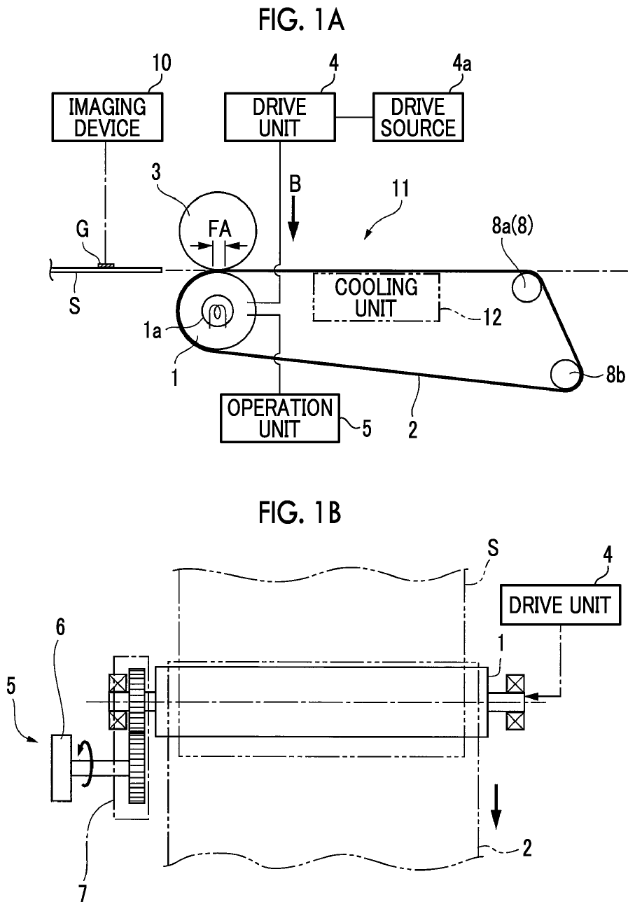

FIG. 1A is a diagram showing an overview of an exemplary embodiment of an image forming system that includes a fixing device to which the present invention is applied.

In FIG. 1A, the image forming system includes an imaging device 10 that generates an unfixed image G on a medium S, and a fixing device 11 that fixes the unfixed image G held on the medium S.

In this example, the fixing device 11 is a fixing device that heats and pressurizes a medium S on which an unfixed image G is held to fix the unfixed image G. The fixing device 11 includes a heating fixing part 1 that includes a heating source 1a, a belt-like transport fixing part 2 that is stretched and rotatably provided around the heating fixing part 1 and is in contact with an image surface of the medium S to transport the medium S, a pressure fixing part 3 that is disposed to face the heating fixing part 1 with the transport fixing part 2 interposed therebetween and is pressurized to form a fixing region FA between the heating fixing part 1 and the pressure fixing part 3, a drive unit 4 that drives the transport fixing part 2 to rotate the transport fixing part 2 with a driving force generated from a drive source 4a, and an operation unit 5 that is operated to manually rotate the transport fixing part 2 in a state where the drive unit 4 is not used.

In such technical means, the fixing device 11 according to the present exemplary embodiment may be incorporated into an image forming apparatus including the imaging device 10 that generates an unfixed image G, or may be incorporated into a post-processing apparatus separate from the image forming apparatus and configured as an image forming system including a plurality of units.

Further, the heating fixing part 1 includes, for example, a heating fixing roller. The heating source 1a may be either a built-in heating source or an external heating source. Furthermore, the transport fixing part 2 includes a transport fixing belt. The transport fixing belt may be appropriately selected, and examples of the transport fixing belt include an aspect in which a coating layer having high releasability, such as fluororubber, is formed on the surface of a belt base material formed of a resin or metal. Further, a transport direction of the medium S transported by the transport fixing part 2 is not limited to a substantially horizontal direction, and may be either an obliquely inclined direction or a substantially vertical direction. Furthermore, the pressure fixing part 3 may have a roller shape or a belt shape as long as being pressurized to form the fixing region between the heating fixing part 1 and the pressure fixing part 3.

Further, any may be appropriately selected as the drive unit 4 as long as transmitting a driving force generated from the drive source 4a, such as a motor, to the transport fixing part 2. In this case, any of other stretching parts 8 (8a and 8b in this example) may be driven to rotate the transport fixing part 2 without being limited to the heating fixing part 1 that stretches the transport fixing part 2.

Furthermore, the operation unit 5 may have a function of rotating the belt-like transport fixing part 2 in a state where the drive unit 4 is not used. In this case, the operation unit 5 typically includes a rotating operation member 6 (see FIG. 1B) that can be rotationally operated and has a circular cross-sectional shape, a square cross-sectional shape, a faucet handle shape, or the like.

Next, for example, a typical aspect or a desired aspect of the fixing device according to the present exemplary embodiment will be described.

First, examples of a typical aspect of the operation unit 5 include an aspect of the operation unit 5 that includes a rotating operation member 6 used to manually rotate the heating fixing part 1 in a case where the drive unit 4 is not used as shown in FIG. 1B. This example is effective in directly forcibly discharging a medium S sandwiched in the fixing region FA between the heating fixing part 1 and the pressure fixing part 3.

Further, in this example, examples of an aspect of the operation unit 5 include an aspect of the operation unit 5 including a rotating operation member 6 that has a rotating shaft deviated from a rotating shaft of the heating fixing part 1 and an operation force transmission unit 7 that is provided between the rotating operation member 6 and the heating fixing part 1 and transmits a rotational operation force from the rotating operation member 6 to the heating fixing part 1. A rotational operation force large to some extent is required in an aspect in which the heating fixing part 1 is directly rotated by the rotating operation member 6. However, an aspect in which the operation force transmission unit 7 is interposed as in this example is effective in disposing the rotating operation member 6 at a position where the rotating operation member 6 is easily rotationally operated or reducing the rotational operation force of the rotating operation member 6.

Further, a support structure for the operation unit 5 may be appropriately selected.

Here, examples of the support structure for the operation unit 5 include an aspect of the support structure including a support unit (not shown) that includes a first support member (not shown) supporting the pressure fixing part 3 and a second support member (not shown) supporting the heating fixing part 1 and the transport fixing part 2 and in which the first support member is provided to be oscillatable about an oscillation fulcrum relative to the second support member, in which the operation unit 5 is held on a side of the second support member to be manually rotatable. In this example, the second support member supports an object, which is heavier than an object supported by the first support member, as a support target. For this reason, the second support member is formed to have a structure having stiffness higher than the stiffness of the first support member. Accordingly, in a case where the operation unit 5 is to be provided, it is preferable that, for example, the operation unit 5 is provided on the second support member having higher stiffness.

Further, examples of an aspect desirable in supporting the operation unit 5 on the second support member include, for example, an aspect in which the operation unit includes a rotating operation member 6 that is disposed on a side of the second support member opposite to the oscillation fulcrum with the heating fixing part 1 interposed therebetween, and an operation force transmission unit 7 that is provided between the rotating operation member 6 and the heating fixing part 1, transmits a rotational operation force of the rotating operation member 6 to the heating fixing part 1, and rotates the heating fixing part 1 in a direction in which the heating fixing part 1 is pressed against a side of the pressure fixing part 3. Here, in a case where the rotating operation member 6 is disposed on a side identical to the oscillation fulcrum and the rotational operation force of the rotating operation member 6 is transmitted to the heating fixing part 1 via the operation force transmission unit 7, the heating fixing part 1 is rotated in a direction in which the heating fixing part 1 is separated from the pressure fixing part 3. In this case, the rotational operation force of the rotating operation member 6 is likely to affect the bending, deformation, and breakage of the second support member. However, this aspect is preferable in, for example, making it difficult for the rotational operation force of the rotating operation member 6 to affect the bending and the like of the second support member.

Further, examples of an aspect of the operation unit 5 include an aspect of the operation unit 5 including a rotating operation member 6 that rotates the transport fixing part 2 in a predetermined direction or both normal and reverse directions in a case where the drive unit 4 is not used. In this example, any one of a normal rotation direction of the transport fixing part 2 (corresponding to a direction in which a medium S is transported), a reverse rotation direction of the transport fixing part 2, and both the normal and reverse directions of the transport fixing part 2 may be appropriately selected as a rotational operation direction of the rotating operation member 6.

In this example, for example, an aspect of the operation unit 5 including the operation force transmission unit 7 that stops the rotation of the rotating operation member 6 in a case where the transport fixing part 2 is rotated by the drive unit 4 and transmits the rotational operation force of the rotating operation member 6 to the transport fixing part 2 in a case where the drive unit is not used is preferable as the operation unit 5. In this example, the transport fixing part 2 is stopped without being rotated while following the rotating operation member 6 in a case where the transport fixing part 2 is rotated by the drive unit 4. For this reason, the rotating operation member 6 is maintained in a stopped state while the transport fixing part 2 is driven to rotate.

Examples of an aspect of the operation force transmission unit 7 in a case where this type of operation unit 5 is embodied include an aspect of the operation force transmission unit 7 including a movable transmission member that is moved to a transmission position from a retreat position while following the rotational operation of the rotating operation member 6 and a biasing member that biases the movable transmission member to hold the movable transmission member at the retreat position in a case where the rotating operation member 6 is being stopping.

Further, examples of another aspect of the operation unit 5 include an aspect of the operation unit 5 including a rotating operation member 6 that rotates the transport fixing part 2 in a case where the drive unit 4 is not used and an operation force transmission unit 7 that transmits a rotational operation force from the rotating operation member 6 to the transport fixing part 2 to rotate the transport fixing part 2, in which the operation force transmission unit 7 includes a reduction element (not shown) that reduces the rotational speed of the transport fixing part 2 with respect to the rotational speed of the rotating operation member 6.

The reduction element mentioned here includes an element that rotates the transport fixing part 2 with a rotational force larger than the rotational operation force of the rotating operation member 6.

Furthermore, examples of another aspect of the operation unit 5 include an aspect of the operation unit 5 including a rotating operation member 6 that rotates the transport fixing part 2 in a case where the drive unit 4 is not used, an operation force transmission unit 7 that transmits a rotational operation force from the rotating operation member 6 to the transport fixing part 2 to rotate the transport fixing part 2, and a support unit (not shown) that supports the rotating operation member 6 and the operation force transmission unit 7, in which the support unit includes a cover member covering the operation force transmission unit 7. In this example, the operation force transmission unit 7 is not exposed to the outside since the cover member is added to the support unit. Accordingly, this example is effective in avoiding a situation in which a user touches the operation force transmission unit 7 by mistake.

Further, for example, an aspect of the operation unit 5 including a cleaning unit (not shown) that is disposed in contact with a peripheral surface of the heating fixing part 1 and cleans the peripheral surface of the heating fixing part 1, a rotating operation member 6 that rotates the heating fixing part 1 in a case where the drive unit 4 is not used, and a retreat unit that causes the cleaning unit to retreat from the peripheral surface of the heating fixing part 1 in conjunction with the rotation of the rotating operation member 6 is preferable as another aspect of the operation unit 5. In this example, the cleaning unit retreats from the peripheral surface of the heating fixing part 1 in a case where the rotating operation member 6 is operated to be rotated manually. For this reason, since frictional resistance caused by sliding contact between the heating fixing part 1 and the cleaning unit does not act in a case where the rotating operation member 6 is operated to be rotated, the rotational operation force of the rotating operation member 6 is reduced to that extent.

Furthermore, in an aspect in which the transport fixing part 2 is manually rotated in both normal and reverse directions, in a case where the cleaning unit retreats from the heating fixing part 1 in the case of a reverse rotation direction, it is preferable in that, for example, the turnover of the cleaning unit with respect to the heating fixing part 1 can also be prevented.

Moreover, examples of an aspect of the fixing device 11 include an aspect of the fixing device 11 including a cooling unit 12 that is provided in contact with a back of a medium transport region of the transport fixing part 2 at a portion of the transport fixing part 2 on a downstream side of the fixing region FA in the transport direction of the medium S and cools the transport fixing part 2. Here, the cooling unit 12 may be appropriately selected, but a heat dissipation unit that dissipates absorbed heat, for example, a heat sink is mostly used as the cooling unit 12.

A fixing method in which an unfixed image G is heated, pressurized, and then cooled is employed in this example. This example is effective in obtaining a glossy image, such as a photographic image, by using the transport fixing part 2 and a dedicated medium as the medium S.

Here, a member having a structure having high smoothness, for example, an aspect in which a coating layer having high smoothness, such as fluororubber or silicone rubber, is formed on a surface of an endless film made of a thermosetting polyimide resin is used as the transport fixing part 2. Further, a dedicated medium S including an image receiving layer in which an unfixed image G is to be embedded by heating and pressurization is used as the medium S. In a case where a fixing method including the cooling unit 12 is employed using the transport fixing part 2 and the dedicated medium S described above, the following fixing processing is performed. That is, in a case where cooling processing is performed by the cooling unit 12 after the unfixed image G is embedded in the image receiving layer provided on the surface of the medium S, surface properties of the transport fixing part 2 are copied and the surface of the image receiving layer and the surface of the image become substantially uniform. As a result, a glossy image is obtained.

The present invention will be described in more detail on the basis of exemplary embodiments shown in the accompanying drawings.

### First Exemplary Embodiment

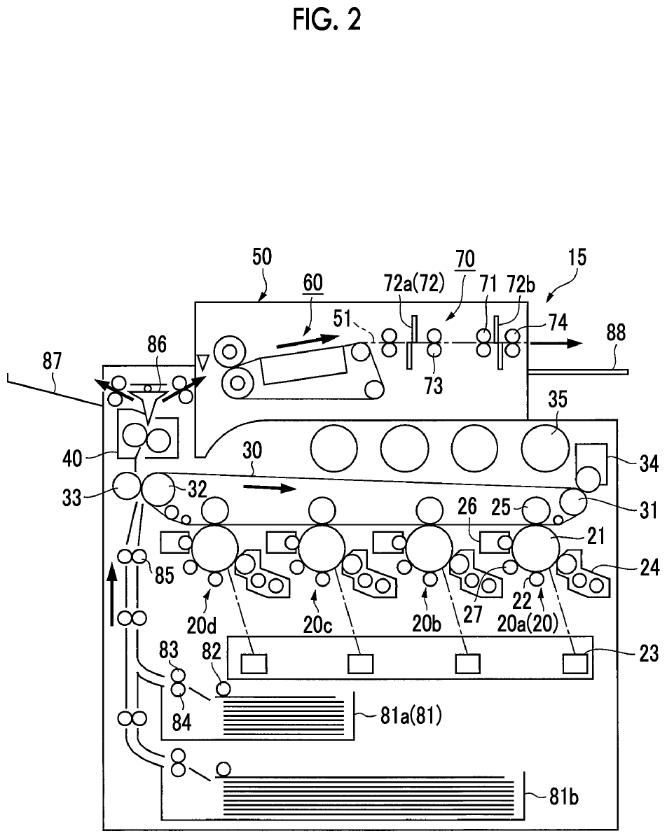

FIG. 2 shows the overall configuration of an image forming system according to a first exemplary embodiment.

### Overall Configuration of Image Forming System

In FIG. 2, the image forming system 15 includes an apparatus body 16 that includes an image forming unit in which color images can be formed, a post-processing apparatus 50 as an optional apparatus is additionally mounted on an upper portion of the apparatus body 16, and a multi-stage medium feed container 81 (81a and 81b) that feeds mediums, such as sheets, are accommodated in a lower portion of the apparatus body 16 to be drawable.

### Image Forming Unit

The image forming unit used in the present exemplary embodiment employs, for example, an electrophotographic method, and has a so-called tandem configuration in which image forming sections 20 (20a to 20d) corresponding to four colors, that is, yellow (Y color), magenta (M color), cyan (C color), and black (K color) are arranged side by side along a belt-like intermediate transfer body 30. For this reason, respective color toner images formed by the respective image forming sections 20 (20a to 20d) are sequentially primarily transferred onto the intermediate transfer body 30 and multiplexed, and this multiplexed toner images are collectively transferred and fixed onto a medium transported from the medium feed container 81. The color arrangement of the image forming sections 20 corresponding to the four colors is not limited to this order, and may be in any other order.

Each of the image forming sections 20 (20a to 20d) of the present exemplary embodiment includes: a photoreceptor 21 as an image holder that forms and holds a toner image corresponding to each color component; a charging part 22 such as a charging roller that charges the photoreceptor 21; an exposure part 23 such as a laser scanner that forms a latent image on the charged photoreceptor 21; a developing part 24 that visualizes the electrostatic latent image formed on the photoreceptor 21; a primary transfer part 25 that primarily transfers the toner image formed on the photoreceptor 21 onto the intermediate transfer body 30 and is formed of, for example, a primary transfer roller; a photoreceptor cleaner 26 that cleans off residual toner remaining on the photoreceptor 21; a charge remover 27 that removes residual charges present on the photoreceptor 21; and the like. Meanwhile, the exposure part 23 in the present exemplary embodiment is adapted such that the exposure of all the image forming sections 20 (20a to 20d) corresponding to the four colors is performed by one exposure part.

Further, the intermediate transfer body 30 is stretched around a plurality of stretching rollers. For example, a stretching roller 31 is a drive roller and is to circularly transport the intermediate transfer body 30, and a stretching roller 32 is disposed to face a secondary transfer part 33, which is formed of, for example, a secondary transfer roller, as a backup roller of the secondary transfer part 33. Furthermore, an intermediate transfer body cleaner 34, which removes residual toner remaining on the intermediate transfer body 30, is provided at a position facing the stretching roller 31 on the intermediate transfer body 30.

In addition, toner boxes 35 corresponding to the four colors that supply toners corresponding to the developing parts 24 of the respective image forming sections 20 are provided above the intermediate transfer body 30 in the apparatus body 16, and supply toners to the developing parts 24 corresponding to the respective colors via transport paths (not shown).

Moreover, a medium transport system 80 of the present exemplary embodiment is as follows. Mediums sent out from each medium feed container 81 by a pickup roller 82 are separated by the action of a feed roller 83 and a retard roller 84 and only one medium is transported to a transport path on the downstream side. Further, registration rollers 85 that position and register the medium transported from the medium feed container 81 before the medium enters the secondary transfer part 33 and a first fixing unit 40 that fixes unfixed toner images transferred onto the medium by the secondary transfer part 33 are provided on the transport path. Furthermore, a switching member 86 is provided on the downstream side of the first fixing unit 40, and the switching member 86 is switched, so that a medium discharged from the first fixing unit 40 is switched to paths in two directions toward the post-processing apparatus 50 and a first discharge tray 87 accommodating a medium directly discharged from the apparatus body 16.

Although two medium feed containers 81a and 81b that accommodate mediums having different sizes are shown as the medium feed container 81, the medium feed container 81 is not limited thereto and three or more medium feed containers may be provided or one medium feed container may be provided. Further, a manual feeder (not shown) may be provided and a medium may be guided from the manual feeder to a transport path.

Furthermore, the first fixing unit 40 of the present exemplary embodiment is, for example, as follows. The first fixing unit 40 includes: a heating fixing roller 41 that includes a heating source (not shown), such as a halogen lamp, therein; and a pressure fixing roller 42 that is disposed to face the heating fixing roller 41, sandwiches a medium in a fixing region formed between the heating fixing roller 41 and the pressure fixing roller 42, and transports the medium.

For this reason, when the medium on which the unfixed toner images are held passes through the fixing region of the first fixing unit 40, the unfixed toner images formed on the medium are fixed onto the medium by heat and pressure.

The first fixing unit 40 employs the configuration of a pair of heating pressure rollers in this example, but is not limited thereto. A method in which a pressure pad is disposed to face a heating fixing roller, a pressure belt interlocking with the heating fixing roller is interposed between the heating fixing roller and the pressure pad, a medium is sandwiched in a fixing region formed between the heating fixing roller and the pressure belt, and an image is fixed to the medium by heat and pressure may be appropriately selected.

### Configuration Example of Post-Processing Apparatus

Further, as shown in FIG. 2, the post-processing apparatus 50 of the present exemplary embodiment includes a second fixing unit 60 that is provided in the middle of a transport path 51 for a medium and makes a toner image surface of the medium highly glossy, and a cutting device 70 that cuts the medium having passed through the second fixing unit 60. In the present exemplary embodiment, a second discharge tray 88 is provided on the downstream side of the post-processing apparatus 50 and the medium having passed through the cutting device 70 is accommodated on the second discharge tray 88.

### Basic Configuration of Second Fixing Unit

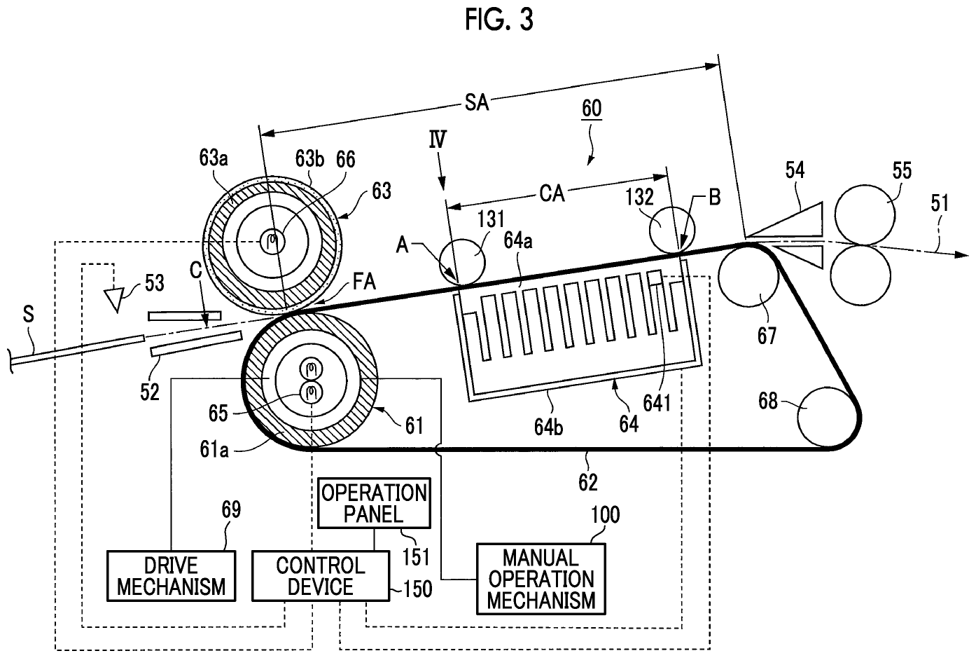

The second fixing unit 60 has a basic configuration identical to the configuration of the fixing device 11 shown in FIG. 1A. That is, as shown in FIGS. 2 and 3, the second fixing unit 60 includes a heating fixing roller 61 as a heating fixing part, a transport fixing belt 62 as a transport fixing part that is stretched and circulatably provided around the heating fixing roller 61 and is in contact with an image surface of a medium S to transport the medium S, a pressure fixing roller 63 as a pressure fixing part that is disposed to face the heating fixing roller 61 with the transport fixing belt 62 interposed therebetween and is pressurized to form a fixing region FA between the heating fixing roller 61 and the pressure fixing roller 63, and a cooler 64 as a cooling unit that is provided in contact with a back of a medium transport region SA of the transport fixing belt 62 at a portion of the transport fixing belt 62 on a downstream side of the fixing region FA in the transport direction of the medium S and cools the transport fixing belt 62.

### Heating Fixing Roller

The heating fixing roller 61 has a configuration in which a release layer (not shown) formed of a PFA tube or the like is formed around a core 61a made of a metal having a high thermal conductivity, heating sources 65, such as halogen lamps, (two heating sources in this example) are provided in the core 61a, and heating is controlled so that the surface of the heating fixing roller 61 is heated up to a predetermined temperature by the heating sources 65. Further, in the present exemplary embodiment, the heating fixing roller 61 is rotationally driven by a drive mechanism 69 as a drive unit and the transport fixing belt 62 is circularly rotated by the heating fixing roller 61.

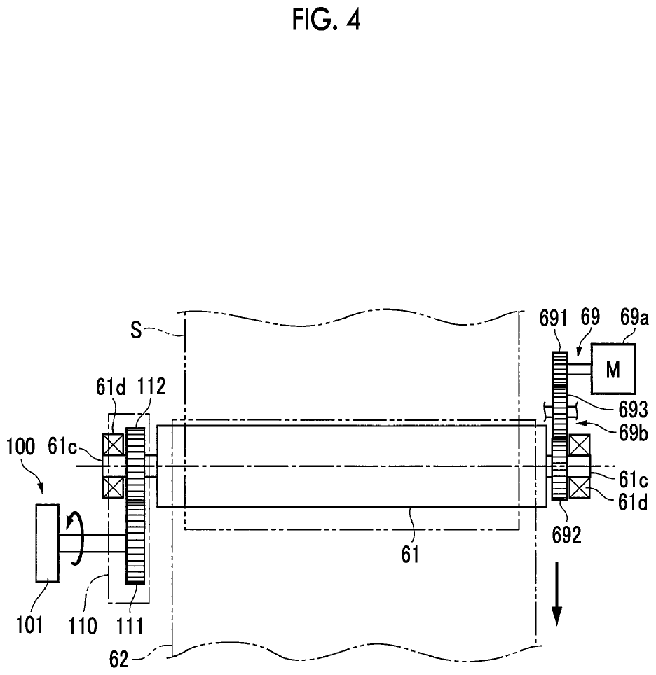

Here, as shown in FIG. 4, the heating fixing roller 61 includes rotating shafts 61c at both end portions of the core 61a in an axial direction thereof and the rotating shafts 61c are rotatably supported by bearings 61d. Further, as shown in FIG. 4, the drive mechanism 69 is provided on a back side of the heating fixing roller 61 in the axial direction (corresponding to a rear surface side of the apparatus body 16 shown in FIG. 2). The drive mechanism 69 includes a drive motor 69a and a drive transmission gear train 69b that transmits a rotational driving force of the drive motor 69a to the heating fixing roller 61. In this example, the drive transmission gear train 69b includes a drive gear 691 that is provided coaxially with a rotating shaft of the drive motor 69a, a final transmission gear 692 that is provided coaxially with the rotating shaft 61c on the back side of the heating fixing roller 61, and one or a plurality of intermediate transmission gears 693 (one intermediate transmission gear is used in this example) that are interposed between the drive gear 691 and the final transmission gear 692.

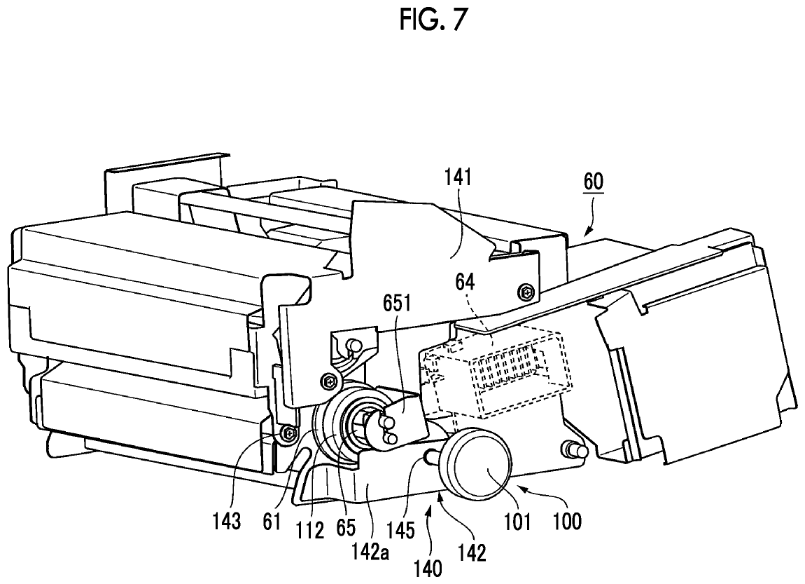

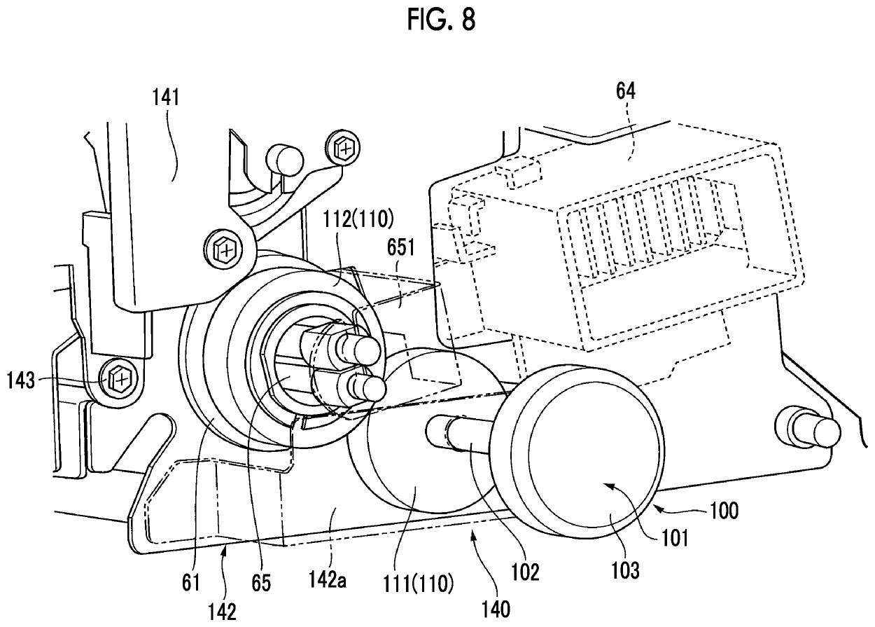

As shown in FIGS. 7 and 8, electrode holders 651 that hold and energize the heating sources 65 are provided at both end portions of the heating fixing roller 61 in the axial direction.

### Transport Fixing Belt

The transport fixing belt 62 is, for example, a belt in which a coating layer having high smoothness, such as fluororubber or silicone rubber, is formed on a surface of an endless film made of a thermosetting polyimide resin.

A base material and a coating layer having appropriate thicknesses are selected as a base material and a coating layer of the transport fixing belt 62 to maintain mechanical strength and to effectively use thermal energy. For example, a belt in which a coating layer having a thickness of about 35 μm is formed on a base material having a thickness of about 75 μm is used.

Further, the transport fixing belt 62 is stretched around the heating fixing roller 61, a release roller 67, and a steering roller 68, and is adapted to be capable of being circularly rotated with the rotation of the heating fixing roller 61.

Here, the release roller 67 is rotated while following the movement of the transport fixing belt 62, and the release roller 67 is adapted to suddenly change the movement direction of the transport fixing belt 62 by stretching the transport fixing belt 62 while winding the transport fixing belt 62. For this reason, the medium S on the transport fixing belt 62 is naturally released from the transport fixing belt 62 at a position of the release roller 67 due to the rigidity of the medium S itself. Further, the steering roller 68 is to always tension the transport fixing belt 62 itself. The steering roller 68 presses the transport fixing belt 62 outward to maintain tension and corrects a deviation (a phenomenon in which the transport fixing belt 62 is moved toward any one end portion of the steering roller 68) occurring in a case where the transport fixing belt 62 is circularly moved.

### Pressure Fixing Roller

Meanwhile, in the pressure fixing roller 63, an elastic layer 63b, such as silicone rubber, is coated around a core 63a made of a metal having a high thermal conductivity and a release layer (not shown) identical to the release layer of the heating fixing roller 61 is formed on the surface of the elastic layer 63b. Further, in the present exemplary embodiment, a heating source 66, such as a halogen lamp, (one heating source is used in this example) is provided even in the core 63a of the pressure fixing roller 63 and heating is controlled so that the surface of the pressure fixing roller 63 is heated up to a predetermined temperature. For this reason, the medium S transported to the second fixing unit 60 is heated and pressurized in the fixing region FA between the heating fixing roller 61 and the pressure fixing roller 63 in a state where the toner image surface of the medium S is in contact with the transport fixing belt 62. Meanwhile, the pressure fixing roller 63 includes the heating source 66 in this example, but may not include the heating source 66.

### Cooler

In the present exemplary embodiment, the cooler 64 is provided in contact with the back of the transport fixing belt 62 in a region between the heating fixing roller 61 and the release roller 67 (corresponding to the medium transport region SA). The cooler 64 is in contact with a part of the medium transport region SA of the transport fixing belt 62, and this contact region is defined as a cooling region CA. That is, the cooler 64 is adapted to cool the transport fixing belt 62 by absorbing heat of the transport fixing belt 62 in the cooling region CA. For this reason, the medium S, which is transported in close contact with the transport fixing belt 62, is cooled.

The cooler 64 in the present exemplary embodiment corresponds to a so-called heat sink. The cooler 64 includes a fin member 64a that is provided with a lot of heat dissipation fins extending in a direction substantially orthogonal to a surface along the transport fixing belt 62, and a cover 64b that is provided to cover the fin member 64a and has the shape of a tube having a rectangular cross-section. Further, this cooler 64 causes air to flow therein by an air blower (not shown) to forcibly dissipate the heat of the fin member 64a.

Meanwhile, for example, a temperature sensor 641 is provided at a part of the fin member 64a of the cooler 64, and the cooler 64 is adapted to adjust ON/OFF or air volume of the air blower (not shown) on the basis of a detection result of the temperature sensor 641.

### Contrivance for Close Contact Transportability of Medium

From the standpoint of ensuring a cooling effect of the cooler 64, a technique in which a medium S transported by the transport fixing belt 62 is disposed in close contact with the cooling region CA of the cooler 64 as shown in FIG. 3 has been contrived in the present exemplary embodiment.

In this example, an inlet-side opposing roller 131 as an opposing rotating part is provided at a position corresponding to the inlet (upstream start point A) of the cooling region CA of the cooler 64 on a surface side of the transport fixing belt 62. This inlet-side opposing roller 131 is disposed in contact with the transport fixing belt 62, and is rotated while following the transport fixing belt 62.

Further, an outlet-side opposing roller 132 as an opposing rotating part is provided at a position corresponding to the outlet (downstream end point B) of the cooling region CA of the cooler 64 on the surface side of the transport fixing belt 62. This outlet-side opposing roller 132 is disposed in contact with the transport fixing belt 62, and is rotated while following the transport fixing belt 62.

In this example, the inlet-side opposing roller 131 needs to be provided at a position corresponding to the inlet of the cooling region CA. Accordingly, the medium S transported on the transport fixing belt 62 is drawn in by the inlet-side opposing roller 131 at the inlet of the cooling region CA to be in close contact with the transport fixing belt 62.

Meanwhile, the outlet-side opposing roller 132 and the inlet-side opposing roller 131 are effective in causing the medium S to be in close contact with the transport fixing belt 62 at two positions on the front and rear sides in the transport direction of the medium S. However, although the outlet-side opposing roller 132 is provided at a position corresponding to the outlet of the cooling region CA, the outlet-side opposing roller 132 is not limited thereto and may be provided on the upstream side of the outlet of the cooling region CA.

### Support Structure for Second Fixing Unit

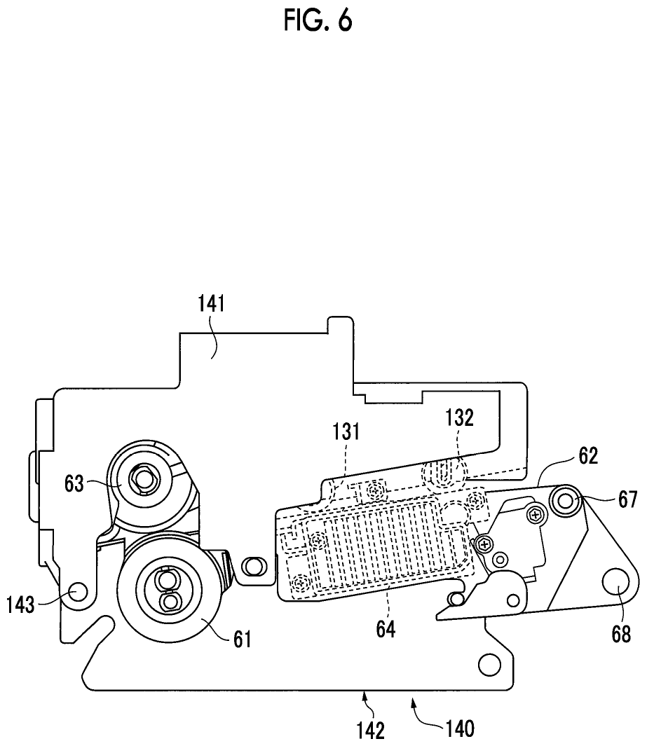

In this example, the second fixing unit 60 supports each element with a support frame 140 as shown in FIGS. 6 and 7.

In this example, the support frame 140 includes an upper frame 141 as a first support member that supports the pressure fixing roller 63, the inlet-side opposing roller 131, and the outlet-side opposing roller 132, and a lower frame 142 as a second support member that supports the heating fixing roller 61, the transport fixing belt 62, and the cooler 64, and the upper frame 141 is provided to be oscillatable about an oscillation shaft 143, which serves as an oscillation fulcrum, relative to the lower frame 142.

In this example, the support frame 140 is obtained in a case where a plate made of SUS or the like is appropriately bent or drilled. In particular, in this example, the upper frame 141 is formed to have a structure having stiffness higher than the stiffness of the lower frame 142 since the weight of the heating fixing roller 61, the transport fixing belt 62, and the cooler 64 is larger than the weight of the pressure fixing roller 63, the inlet-side opposing roller 131, and the outlet-side opposing roller 132.

### Peripheral Structure of Second Fixing Unit

Further, in this example, an inlet guide member 52 that guides a medium S to an inlet of the second fixing unit 60 and a position sensor 53 that detects the position of the front end or the rear end of the medium S passing through the transport path 51 are provided near the inlet of the second fixing unit 60.

Furthermore, an outlet guide member 54 that guides the medium S discharged from an outlet of the second fixing unit 60 is provided near the outlet of the second fixing unit 60, and transport rollers 55 are provided on the downstream side of the outlet guide member 54.

### Selection of Medium

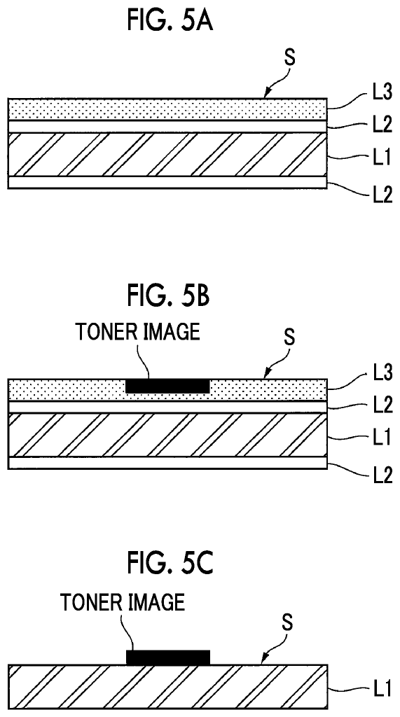

Usually, in order to obtain a high-gloss image, such as a photographic image, it is preferable that, for example, a dedicated sheet shown in FIG. 5A is used as a medium S. As shown in FIG. 5A, the dedicated sheet includes moisture-proof layers L2 on both surfaces of a base material layer L1 and further includes an image receiving layer L3 on a recording surface (toner image formation surface) side.

The moisture-proof layer L2 is made of a resin without air-permeability, such as polyethylene, and a moisture-proof effect of the base material layer L1 is obtained as long as the moisture-proof layer L2 has a thickness of about several μm. Further, for example, the image receiving layer L3 contains a thermoplastic resin, such as polyester having a melting temperature of about 130° C., as a major component, and is formed to have a thickness of 5 to 20 μm, preferably, about 10 μm. Meanwhile, the base material layer L1 has composition in which cellulose is contained as a major component, and has composition identical to the composition of plain paper. However, for example, a dedicated base material layer L1 having different composition can also be used.

Accordingly, in a case where moisture-proof layers L2 are provided on both surfaces of a base material layer L1 and an image receiving layer L3 made of a material identical to a toner material is further provided as in photographic paper used for a silver halide photograph, it is possible to eliminate air-permeability and to prevent a problem that the base material layer L1 may be stretched to cause curl or a toner image may be stretched to be cracked due to the absorption of moisture in the base material layer L1 under a high-humidity environment. Further, a toner image is melted together with the image receiving layer L3 and pressure is applied to satisfactorily embed the toner image in the image receiving layer L3, so that a smooth printed surface can be obtained.

In a case where fixing is performed using such a dedicated sheet by the second fixing unit 60 in a photographic print mode, the toner image is embedded in the image receiving layer L3 as shown in FIG. 5B. In this case, surface properties of the transport fixing belt 62 of the second fixing unit 60 are copied and the surface of the image receiving layer L3 and the surface of the toner image become substantially uniform, so that a glossy image is obtained. Meanwhile, FIG. 5C shows a state where a toner image is fixed to plain paper as a medium S by only the first fixing unit 40 in a plain paper print mode. In this case, only an image having poor glossiness is obtained since the toner image is placed on the base material layer L1 and the toner image protrudes from the surface of the image.

### Characteristic Configuration of Second Fixing Unit

### Necessity of Manual Operation Mechanism

In the present exemplary embodiment, as shown in FIGS. 3 and 4, the second fixing unit 60 includes a manual operation mechanism 100 as an operation unit that is operated to manually rotate the transport fixing belt 62 in a state where the drive mechanism 69 is not used.

With regard to the manual operation mechanism 100, for example, in a case where the medium S transported along the transport fixing belt 62 is jammed in the second fixing unit 60, the drive mechanism 69 is urgently stopped and the operation of the second fixing unit 60 is stopped. At this time, in a case where the jammed medium S remains in the second fixing unit 60, a situation in which the temperature of the fixing region FA of the second fixing unit 60 is not immediately lowered and the medium S sandwiched in the fixing region FA continues to be heated occurs even though the operation of the second fixing unit 60 is stopped. For this reason, it is not preferable that the jammed medium S remains in the second fixing unit 60.

Accordingly, this example is to manually rotate the transport fixing belt 62, for example, in the transport direction of the medium S with the manual operation mechanism 100 to forcibly discharge the jammed medium S from the second fixing unit 60.

### Configuration Example of Manual Operation Mechanism

In the present exemplary embodiment, as shown in FIGS. 3 and 4 and FIGS. 6 to 9, the manual operation mechanism 100 includes a rotating operation handle 101 as a rotating operation member that is used to manually rotate the heating fixing roller 61, and an operation force transmission mechanism 110 as an operation force transmission unit that is provided between the rotating operation handle 101 and the heating fixing roller 61 and transmits a rotational operation force from the rotating operation handle 101 to the heating fixing roller 61.

In this example, the rotating operation handle 101 includes a rotating shaft 102 deviated from the rotating shaft 61c of the heating fixing roller 61 and a handle body 103 is integrally formed on one end side of the rotating shaft 102. In this example, the handle body 103 is integrally molded into a disk shape using, for example, a PC resin or an ABS resin. In this case, the handle body 103 may have a solid structure, or may have a shape that includes a recessed portion on a side facing the rotating shaft 102. Further, an uneven portion for preventing slipping during a rotational operation may be formed on the peripheral surface of the circular handle body 103.

Furthermore, the operation force transmission mechanism 110 includes a first transmission gear 111 that is provided coaxially with the rotating shaft 102 of the rotating operation handle 101, and a second transmission gear 112 which is provided coaxially with the rotating shaft 61c positioned on a front side of the heating fixing roller 61 (corresponding to a front side of the apparatus body 16 in FIG. 2) and meshes with the first transmission gear 111 and to which a rotational operation force is transmitted.

Moreover, a gear ratio between the first transmission gear 111 and the second transmission gear 112 of the operation force transmission mechanism 110 may be appropriately selected. However, in a case where the number of teeth of the first transmission gear 111 is denoted by GA1, the number of teeth of the second transmission gear 112 is denoted by GA2, and “GA2>GA1” is satisfied, the heating fixing roller 61 can be rotated at a rotational speed lower than the rotational speed of the rotating operation handle 101.

### Support Structure for Manual Operation Mechanism

In this example, as shown in FIGS. 7 and 8, the lower frame 142 includes an insertion hole 145 which is provided at a part of a front rising portion 142a and into which the rotating shaft 102 of the rotating operation handle 101 can be inserted. In a state where the handle body 103 is disposed on a front side of the front rising portion 142a of the lower frame 142, the rotating shaft 102 of the rotating operation handle 101 is inserted into the insertion hole 145 of the lower frame 142 via bearings (not shown).

Further, the operation force transmission mechanism 110 is disposed in a space portion between the front rising portion 142a of the lower frame 142 and a front edge portion of the transport fixing belt 62 in a width direction.

### Control System of Second Fixing Unit

In this example, a control system of the second fixing unit 60 includes a control device 150 that is formed of a microcomputer including various processors as shown in FIG. 3. In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

Meanwhile, an operation panel 151 of the image forming system 15 is connected to the control device 150. The operation panel 151 is provided with a start switch that is used to start imaging processing on a medium S, a mode switch that is used to designate an imaging mode, such as single-sided printing, two-sided printing, or high-definition printing, a medium type indicating unit that indicates the type of a medium to be used, and the like.

Further, a program related to a series of image forming processing, and the like are installed in advance in an ROM as a storage device of the control device 150. Furthermore, various detectors, such as the position sensor 53 and the temperature sensor 641, are connected to the control device 150. In addition, various control targets (the drive motor 69a of the drive mechanism 69, the heating sources 65 and 66, and the like) are connected to the control device 150.

Further, the processors of the control device 150 are adapted to receive instruction signals output from the operation panel 151 and detection signals output from the various detectors, to execute the above-mentioned program, and to send an appropriate control signal to each of the control targets.

### Cutting Device

In the present exemplary embodiment, the cutting device 70 is adapted to be capable of cutting a side of a medium and to produce, for example, a borderless print. For this reason, as shown in FIG. 2, the cutting device 70 includes a slitter 71 that cuts both sides of a medium in a width direction, a plurality of circular cutters 72 (72a and 72b) that cut the medium to a length in a feed direction, and a plurality of transport rollers 73 and 74 that transport the medium. The slitter 71 includes blades of which the number corresponds to the number of cuts required in an axial direction, and is adapted to cut the medium in the feed direction while transporting the medium. Further, the circular cutter 72 is adapted to cut the medium by moving a rolling cutter of an upper blade along a lower blade in a state where the transport of the medium is temporarily stopped. As the circular cutter 72, for example, a roller cutter may be provided in an axial direction and may be adapted to cut the medium while the medium is transported.

Further, the cutting device 70 not only has a function of cutting a medium into a plurality of sheets (for example, four sheets) but also can print one L-size image on, for example, a postcard-size medium (100×150 mm) and finish the print without borders. Furthermore, an arbitrary number of L-size digital camera photographs can be obtained from a combination of printing four images on an A4-size medium and printing images on an arbitrary number of postcard-size mediums one by one. Moreover, in a case where the positions of the blades of the slitter 71 in the width direction are made variable, the medium can also be cut into various sizes, such as four pieces, six pieces, and eight pieces.

### Basic Operation of Image Forming System

Next, the basic operation of such an image forming system will be described.

As shown in FIG. 2, multiplexed toner images in which respective color toner images formed by the respective image forming sections 20 (20a to 20d) are multiplexed and which are formed on the intermediate transfer body 30 are collectively transferred onto a medium sent out from the medium feed container 81 by the secondary transfer part 33. After the transferred unfixed toner images are fixed by the first fixing unit 40, the medium is guided to the first discharge tray 87 or guided to the second discharge tray 88 via the post-processing apparatus 50 by the switching member 86.

In the present exemplary embodiment, the switching member 86 switches a medium transport direction as follows. That is, in a plain paper print mode (low-gloss printing) in which a normal image is formed, a medium is discharged to the first discharge tray 87 by the switching member 86 after fixing is performed by the first fixing unit 40. On the other hand, in a photographic print mode (high-gloss printing) in which a high-gloss image, such as a photographic image, is formed, the medium is transported to the second fixing unit 60 by the switching member 86 after fixing is performed by the first fixing unit 40, and the medium is discharged to the second discharge tray 88 via the cutting device 70 after fixing is further performed by the second fixing unit 60. In particular, the cutting device 70 may be used in a case where a borderless print, such as a photographic image, is preferred, and discharges the medium to the second discharge tray 88 without performing cutting in a case where cutting is not particularly necessary.

### Fixing Action of Second Fixing Unit

A fixing action of the second fixing unit 60 is performed as follows.

The medium S guided to the post-processing apparatus 50 via the first fixing unit 40 is to enter the second fixing unit 60 as shown in FIG. 3. In this state, in the second fixing unit 60, the heating fixing roller 61 and the pressure fixing roller 63 are heated up to a temperature at which fixing can be performed by the heating sources 65 and 66, respectively, and the transport fixing belt 62 is circularly rotated with the drive rotation of the heating fixing roller 61.

Further, the cooler 64 drives the air blower in a condition in which the front end of the medium S passes through a predetermined reference position C to stand ready for a state where the cooling operation is performed.

In this state, after the medium S is subjected to heating/pressure fixing processing in the fixing region FA of the second fixing unit 60 and is transported by the transport fixing belt 62, the medium S is subjected to cooling processing performed by the cooler 64. After that, the medium S is discharged from the second fixing unit 60.

Here, in order to obtain a high-gloss image, such as a photographic image, it is preferable that, for example, a dedicated sheet shown in FIG. 5A is used as the medium S.

In a case where fixing is performed using such a dedicated sheet by the second fixing unit 60 in a photographic print mode, the toner image is embedded in the image receiving layer L3 as shown in FIG. 5B. In this case, surface properties of the transport fixing belt 62 of the second fixing unit 60 are copied and the surface of the image receiving layer L3 and the surface of the toner image become substantially uniform, so that a glossy image is obtained.

### Jam Handling of Second Fixing Unit

Now, it is assumed that the medium S is jammed in the second fixing unit 60 while being transported along the transport fixing belt 62 as shown in FIG. 3.

In this case, the operation of the second fixing unit 60 is stopped with the jam of the medium S, and all of the drive motor 69a of the drive mechanism 69, each of the heating sources 65 and 66, and the cooling operation of the cooler 64 are stopped.

In this state, the jammed medium S may be removed using the manual operation mechanism 100. Specifically, as shown in FIGS. 4, 7, and 8, until the medium S is forcibly discharged from the outlet of the second fixing unit 60, the rotating operation handle 101 may be appropriately manually rotated in a predetermined direction (counterclockwise in this example) to rotate the heating fixing roller 61 clockwise (in the normal rotation direction) from the first transmission gear 111 of the operation force transmission mechanism 110 via the second transmission gear 112.

In a case where the heating fixing roller 61 is rotated in the normal rotation direction as described above, the transport fixing belt 62 is moved in the normal rotation direction (the transport direction of the medium S) with the rotation of the heating fixing roller 61 and the pressure fixing roller 63 is also rotated while following the heating fixing roller 61. For this reason, the jammed medium S is transported while being sandwiched in the fixing region FA between the heating fixing roller 61 and the pressure fixing roller 63, and is transported along the transport fixing belt 62. Then, the medium S is forcibly discharged from the outlet of the second fixing unit 60.

Since a gear ratio between the number GA1 of teeth of the first transmission gear 111 of the operation force transmission mechanism 110 and the number GA2 of teeth of the second transmission gear 112 satisfies a relationship of “GA2>GA1” in this example in this case, the rotational speed of the heating fixing roller 61 can be set to be lower than the rotational speed of the rotating operation handle 101. Further, in this example, the rotational operation force of the rotating operation handle 101 can also be set to be smaller than a rotational operation force in a condition of “GA2≤GA1”.

Furthermore, the rotating operation handle 101 is always connected to the heating fixing roller 61 via the operation force transmission mechanism 110 in this example. Accordingly, for example, in a case where the heating fixing roller 61 is driven to rotate by the drive mechanism 69, the drive rotation of the heating fixing roller 61 is transmitted to the rotating operation handle 101 via the operation force transmission mechanism 110. For this reason, during the operation of the second fixing unit 60, the rotating operation handle 101 is also rotated while following the drive rotation of the heating fixing roller 61.

Accordingly, from the standpoint of safety, it is preferable that, for example, a configuration in which the rotating operation handle 101 is covered with an openable and closable cover or the like is employed.

### Layout of Rotating Operation Handle

In the present exemplary embodiment, the rotating operation handle 101 of the manual operation mechanism 100 is disposed on a side opposite to the oscillation shaft 143, which serves as the oscillation fulcrum of the support frame 140, with the heating fixing roller 61 interposed therebetween as the front rising portion 142a of the lower frame 142 is viewed from the front side. Further, the operation force transmission mechanism 110 transmits the rotational operation force of the rotating operation handle 101 to the heating fixing roller 61 and rotates the heating fixing roller 61 in a state where the heating fixing roller 61 is pressed against the pressure fixing roller 63.

As described above, the rotating operation handle 101 can be disposed using a wide plate-like portion of the front rising portion 142a of the lower frame 142 opposite to the oscillation shaft 143. Further, even though a part of the rotational operation force of the rotating operation handle 101 acts on an edge portion of the insertion hole 145 of the front rising portion 142a of the lower frame 142, the heating fixing roller 61 pressed against the pressure fixing roller 63 is held on the lower frame 142 in place. For this reason, there is less concern that a portion of the front rising portion 142a of the lower frame 142 around the rotating operation handle 101 is bent, deformed, or broken with the rotational operation of the rotating operation handle 101.

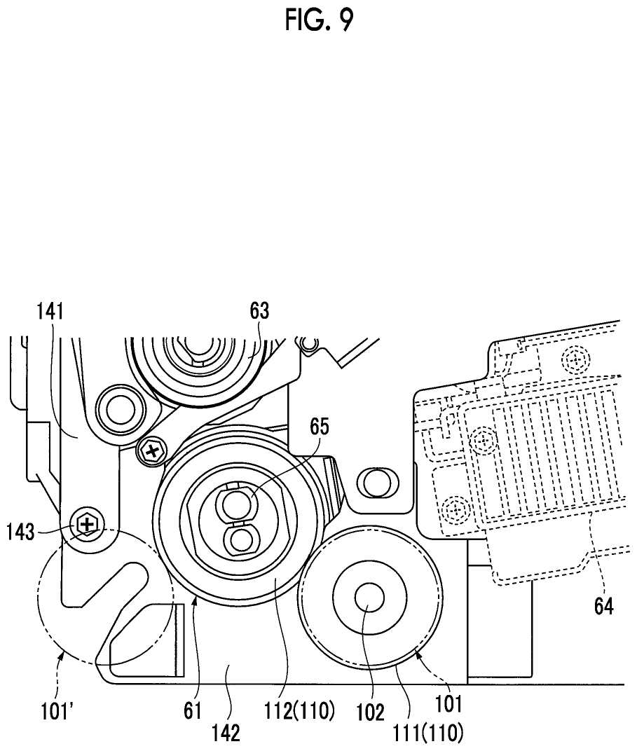

On the other hand, in a case where a rotating operation handle 101′ is disposed on a side identical to the side on which the oscillation shaft 143 serving as the oscillation fulcrum is positioned as shown by a virtual line in FIG. 9, it is difficult to support the rotating operation handle 101′ and to ensure a plate-like portion having high stiffness around the oscillation shaft 143 on the front rising portion 142a of the lower frame 142. Further, in a case where the rotating operation handle 101′ is disposed on a side identical to the side on which the oscillation shaft 143 is positioned and is rotationally operated, the heating fixing roller 61 is rotated in a state where the heating fixing roller 61 is pressed in a direction in which the heating fixing roller 61 is separated from the pressure fixing roller 63. There is a concern that a portion of the front rising portion 142a of the lower frame 142 around the rotating operation handle 101′ is likely to be bent, deformed, or broken with the rotational operation of the rotating operation handle 101′.

### Second Exemplary Embodiment

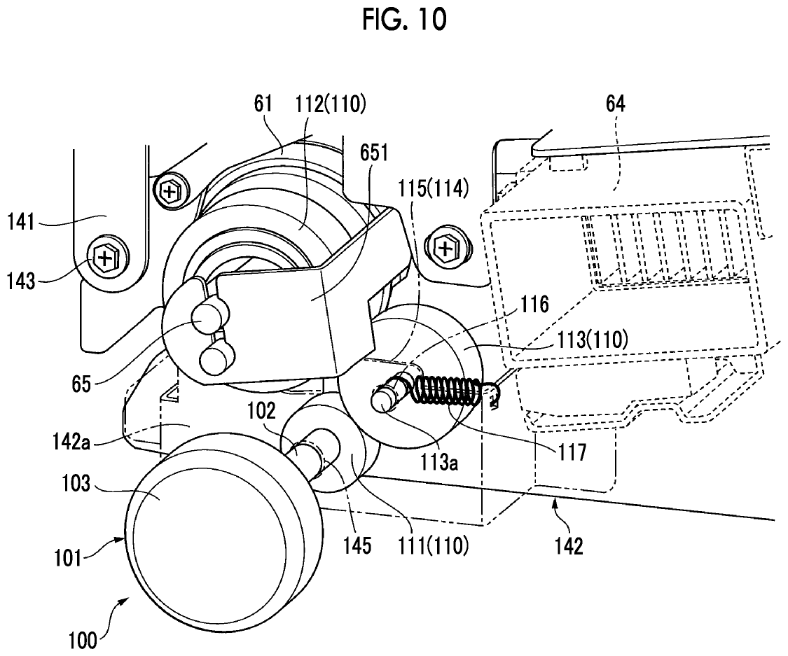

FIG. 10 is a perspective view showing major parts of a manual operation mechanism of a second fixing unit according to a second exemplary embodiment.

In FIG. 10, a basic configuration of the second fixing unit 60 includes a heating fixing roller 61, a transport fixing belt (not shown), a pressure fixing roller (not shown), and a cooler 64 as in the first exemplary embodiment. Further, the manual operation mechanism 100 includes a rotating operation handle 101 and an operation force transmission mechanism 110 as in the first exemplary embodiment, but the configuration of the operation force transmission mechanism 110 is different from the configuration of the operation force transmission mechanism of the first exemplary embodiment. Meanwhile, components identical to the components of the first exemplary embodiment will be denoted by reference numerals identical to the reference numerals of the first exemplary embodiment, and detailed description thereof will be omitted here.

In this example, the operation force transmission mechanism 110 includes a first transmission gear 111 that is provided coaxially with the rotating shaft 102 of the rotating operation handle 101, a second transmission gear 112 that is provided coaxially with the rotating shaft 61c of the heating fixing roller 61, and an intermediate transmission gear 113 that is provided to be interposed between the first transmission gear 111 and the second transmission gear 112.

In a case where gear diameters of the first transmission gear 111, the second transmission gear 112, and the intermediate transmission gear 113 are denoted by D1, D2, and Dm in this example, the gear diameters may be appropriately selected and may be selected to satisfy a relationship of “D1<Dm<D2”.

Further, in this example, the first transmission gear 111 is disposed diagonally below the second transmission gear 112. Furthermore, the intermediate transmission gear 113 is disposed to face the first transmission gear 111 and the second transmission gear 112 from a right side in FIG. 10.

In this example, the intermediate transmission gear 113 is disposed to always mesh with the first transmission gear 111. Further, the intermediate transmission gear 113 is adapted to be movable between a contact position at which the intermediate transmission gear 113 meshes with the second transmission gear 112 and a retreat position at which the intermediate transmission gear 113 retreats from the second transmission gear 112.

The intermediate transmission gear 113 is held by a holding bracket 114 (a part of the front rising portion 142a of the lower frame 142 of the first exemplary embodiment is used in this example) to be movable in a predetermined direction (a direction along an outer peripheral trajectory of the first transmission gear 111 in this example). Specifically, the holding bracket 114 includes a pair of holding pieces 115 that pinches the intermediate transmission gear 113 from both sides, and elongated holding holes 116 extending in a predetermined direction are formed in the holding pieces 115. Further, a holding structure for the intermediate transmission gear 113 is adapted such that a spindle 113a is slidably fitted into the holding holes 116 of the holding bracket 114 and is biased in a direction away from the second transmission gear 112 using a bias spring 117.

Meanwhile, a part of the lower frame 142 is used as the holding bracket 114 in this example, but the holding bracket 114 is not limited thereto. It is natural that the holding bracket 114 may be provided separately from the lower frame 142. Further, it is preferable that, for example, the holding holes 116 of the holding bracket 114 are formed in a direction along the outer peripheral trajectory of the first transmission gear 111, but elongated holes extending linearly or curvedly in a vertical direction or an oblique direction can also be used as the holding holes 116 from a contrivance for a positional relationship between the first transmission gear 111, the second transmission gear 112, and the intermediate transmission gear 113.

### Operation of Manual Operation Mechanism

It is assumed in the present exemplary embodiment that the second fixing unit 60 is operated.

In this case, the drive mechanism 69 rotates and drives the heating fixing roller 61 in the normal rotation direction and causes the transport fixing belt 62 and the pressure fixing roller 63 to rotate while following the heating fixing roller 61.

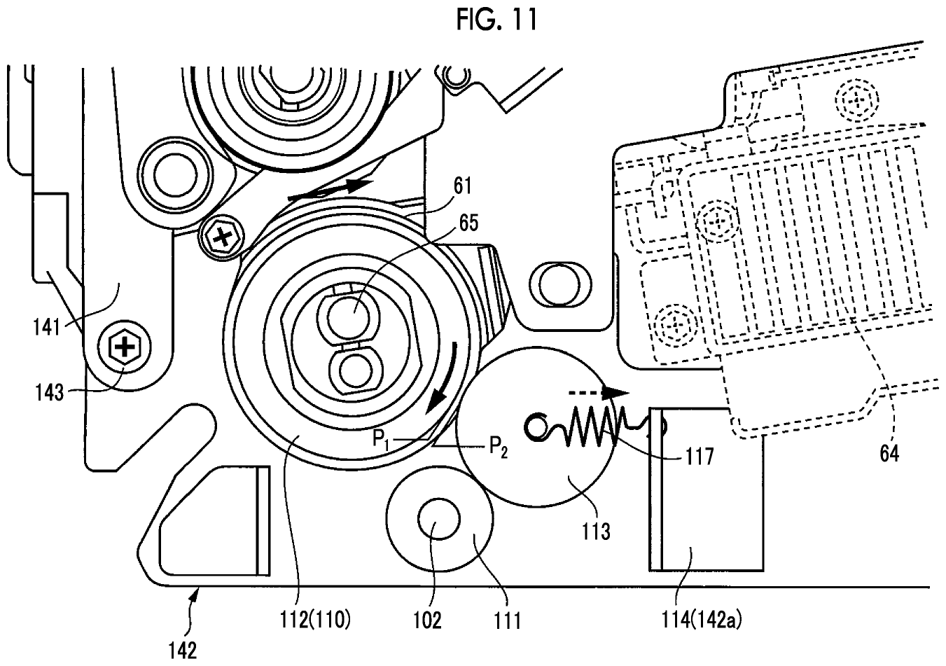

In this state, the rotating operation handle 101 of the manual operation mechanism 100 is not rotationally operated. In this case, the spindle 113a of the intermediate transmission gear 113 of the operation force transmission mechanism 110 is moved to ends of the holding holes 116 of the holding bracket 114, which are away from the second transmission gear 112, by a biasing force of the bias spring 117. For this reason, the intermediate transmission gear 113 retreats to a retreat position P2 away from the second transmission gear 112 while meshing with the first transmission gear 111 as shown in FIG. 11. Accordingly, in a case where the heating fixing roller 61 is driven to rotate, the second transmission gear 112 and the intermediate transmission gear 113 are disposed not to be in contact with each other. For this reason, the drive rotation of the heating fixing roller 61 is not transmitted to the rotating operation handle 101 via the operation force transmission mechanism 110, so that the rotating operation handle 101 is not rotated while following the heating fixing roller 61.

Therefore, from the standpoint of safety, a configuration in which the rotating operation handle 101 is covered with a cover or the like as in the first exemplary embodiment does not need to be employed in the present exemplary embodiment.

Further, it is assumed in the present exemplary embodiment that a medium S is jammed in the second fixing unit 60 while being transported along the transport fixing belt 62.

Since the operation of the second fixing unit 60 is being stopped in this case, the jammed medium S may be removed using the manual operation mechanism 100.

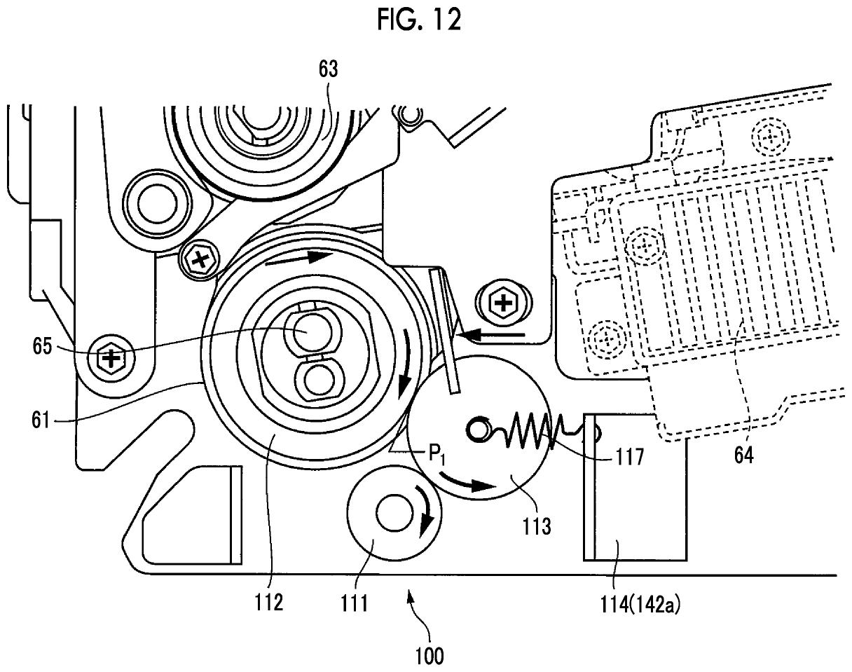

In this example, as shown in FIGS. 10 and 12, the rotating operation handle 101 of the manual operation mechanism 100 may be rotated an appropriate number of times in a predetermined direction (clockwise in this example). Since the first transmission gear 111 is rotated clockwise in this case, the intermediate transmission gear 113 always meshing with the first transmission gear 111 is rotated counterclockwise. Then, a rotational operation force from the first transmission gear 111 is transmitted to the intermediate transmission gear 113 at a meshing portion between the first transmission gear 111 and the intermediate transmission gear 113. For this reason, the intermediate transmission gear 113 is pushed toward the second transmission gear 112 against the biasing force of the bias spring 117, and meshes with the second transmission gear 112.

As the rotating operation handle 101 is rotated an appropriate number of times in a predetermined direction in this state, the rotational operation force is transmitted in an order of the first transmission gear 111, the intermediate transmission gear 113, and the second transmission gear 112 of the operation force transmission mechanism 110. As a result, the heating fixing roller 61 is rotated in the normal rotation direction.

In a case where the heating fixing roller 61 is rotated in the normal rotation direction as described above, the transport fixing belt 62 is moved in the normal rotation direction (the transport direction of the medium S) with the rotation of the heating fixing roller 61 and the pressure fixing roller 63 is also rotated while following the heating fixing roller 61 as in the first exemplary embodiment. For this reason, the jammed medium S is transported while being sandwiched in the fixing region FA between the heating fixing roller 61 and the pressure fixing roller 63, and is transported along the transport fixing belt 62. Then, the medium S is forcibly discharged from the outlet of the second fixing unit 60.

### Configuration Example of Periphery of Manual Operation Mechanism

In the present exemplary embodiment, the operation force transmission mechanism 110 of the manual operation mechanism 100 is adapted such that the intermediate transmission gear 113 is movably held by the holding bracket 114. However as shown in FIG. 10, the intermediate transmission gear 113 is exposed to the outside in a space portion above the holding bracket 114.

In this case, in a case where the intermediate transmission gear 113 is exposed to the outside during the rotational operation of the manual operation mechanism 100, there is a concern that a user is in contact with the intermediate transmission gear 113.

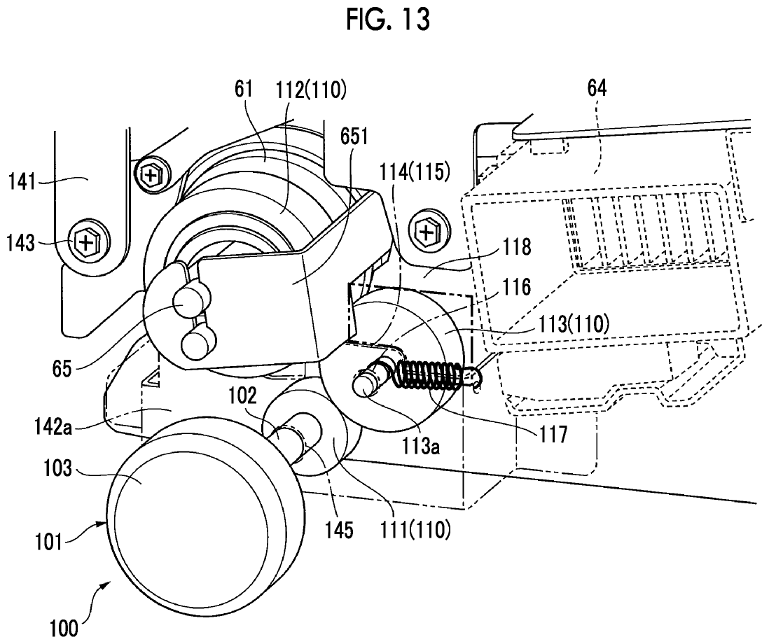

Accordingly, in this example, a concern that a user is in direct contact with the intermediate transmission gear 113 is eased in a case where a position above the holding bracket 114 is covered with a blind cover 118 as shown in FIG. 13.

### Third Exemplary Embodiment

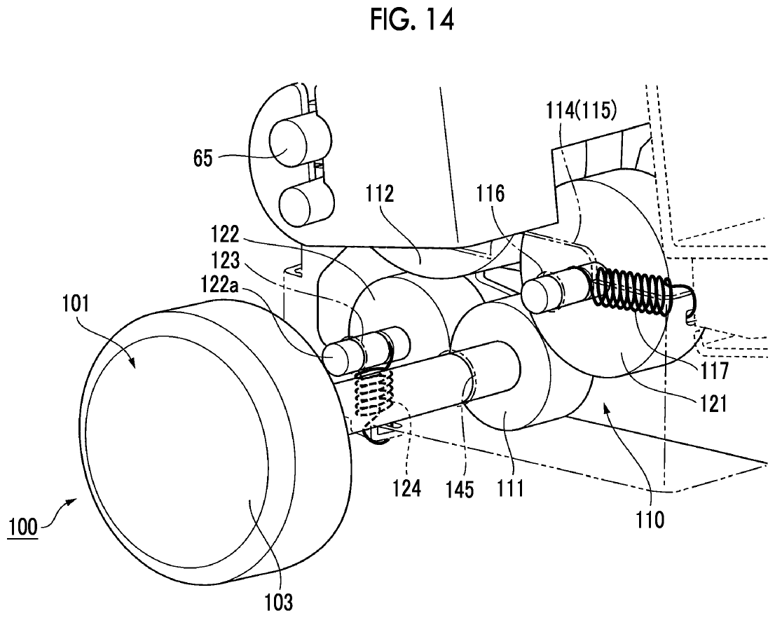

FIG. 14 is a perspective view showing major parts of a manual operation mechanism of a second fixing unit according to a third exemplary embodiment.

In FIG. 14, a basic configuration of the second fixing unit 60 includes a heating fixing roller 61, a transport fixing belt (not shown), a pressure fixing roller (not shown), and a cooler 64 as in the second exemplary embodiment. Further, the manual operation mechanism 100 is to allow the heating fixing roller 61 to be rotatable in both normal and reverse directions, and an operation force transmission mechanism 110 is different from the operation force transmission mechanism of the second exemplary embodiment. Meanwhile, components identical to the components of the second exemplary embodiment will be denoted by reference numerals identical to the reference numerals of the second exemplary embodiment, and detailed description thereof will be omitted here.

In this example, the operation force transmission mechanism 110 of the manual operation mechanism 100 includes a first transmission gear 111 that is provided coaxially with the rotating shaft 102 of the rotating operation handle 101, a second transmission gear 112 that is provided coaxially with the rotating shaft 61c of the heating fixing roller 61, a first intermediate transmission gear 121 (corresponding to the intermediate transmission gear 113 according to the second exemplary embodiment) that is provided to be interposed between the first transmission gear 111 and the second transmission gear 112 and is used to rotate the heating fixing roller 61 in the normal rotation direction, and a second intermediate transmission gear 122 that is provided to be interposed between the first transmission gear 111 and the second transmission gear 112 and is used to rotate the heating fixing roller 61 in the reverse rotation direction.

In this example, as shown in FIGS. 14 to 17, the first intermediate transmission gear 121 is disposed to face the first transmission gear 111 and the second transmission gear 112 from a right side in FIGS. 14 to 17. Further, the second intermediate transmission gear 122 is disposed to face the first transmission gear 111 from a left side in FIGS. 14 to 17 and is disposed to face the second transmission gear 112 from a lower side in FIGS. 14 to 17.

As in the case of the holding structure for the intermediate transmission gear 113 of the second exemplary embodiment, a holding structure for the first intermediate transmission gear 121 is adapted such that holding holes 116 having a predetermined shape are formed in holding pieces 115 of a holding bracket 114 (a part of the front rising portion 142a of the lower frame 142 of the first exemplary embodiment is used in this example) and a spindle 121a is slidably fitted into the holding holes 116 and is biased in a direction away from the second transmission gear 112 using a bias spring 117.

Meanwhile, a holding structure for the second intermediate transmission gear 122 is adapted such that elongated holding holes 123 having a predetermined shape (formed in a direction along an outer peripheral trajectory of the first transmission gear 111 in this example) are formed in the holding pieces 115 of the holding bracket 114 and a spindle 122a is slidably fitted into the holding holes 123 and is biased in a direction away from the second transmission gear 112 (downward in this example) using a bias spring 124.

### Operation of Manual Operation Mechanism

### [1] During Operation of Second Fixing Unit

It is assumed in the present exemplary embodiment that the second fixing unit 60 is operated.

In this case, the drive mechanism 69 rotates and drives the heating fixing roller 61 in the normal rotation direction and causes the transport fixing belt 62 and the pressure fixing roller 63 to rotate while following the heating fixing roller 61.

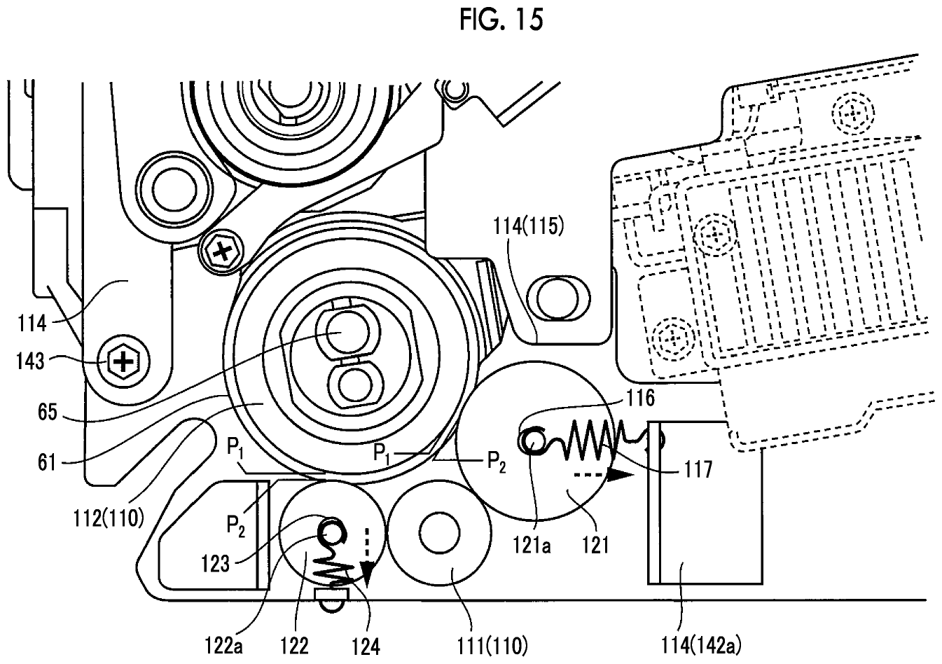

In this state, the rotating operation handle 101 of the manual operation mechanism 100 is not rotationally operated. In this case, the spindle 121a of the first intermediate transmission gear 121 of the operation force transmission mechanism 110 is moved to ends of the holding holes 116 of the holding bracket 114, which are away from the second transmission gear 112, by a biasing force of the bias spring 117. For this reason, the first intermediate transmission gear 121 retreats to a retreat position P2 away from the second transmission gear 112 while meshing with the first transmission gear 111 as shown in FIG. 15.

Meanwhile, the spindle 122a of the second intermediate transmission gear 122 is moved to ends of the holding holes 123 of the holding bracket 114, which are away from the second transmission gear 112, by a biasing force of the bias spring 124. For this reason, the second intermediate transmission gear 122 retreats to a retreat position P2 away from the second transmission gear 112 while meshing with the first transmission gear 111 as shown in FIG. 15.

Accordingly, in a case where the heating fixing roller 61 is driven to rotate, the second transmission gear 112 and the first and second intermediate transmission gears 121 and 122 are disposed not to be in contact with each other. For this reason, the drive rotation of the heating fixing roller 61 is not transmitted to the rotating operation handle 101 via the operation force transmission mechanism 110, so that the rotating operation handle 101 is not rotated while following the heating fixing roller 61.

### [2] During Occurrence of Jam

Further, it is assumed in the present exemplary embodiment that a medium S is jammed in the second fixing unit 60 while being transported along the transport fixing belt 62.

Since the operation of the second fixing unit 60 is being stopped in this case, the jammed medium S may be removed using the manual operation mechanism 100.

Forced Discharge of Medium from Outlet Side of Second Fixing Unit

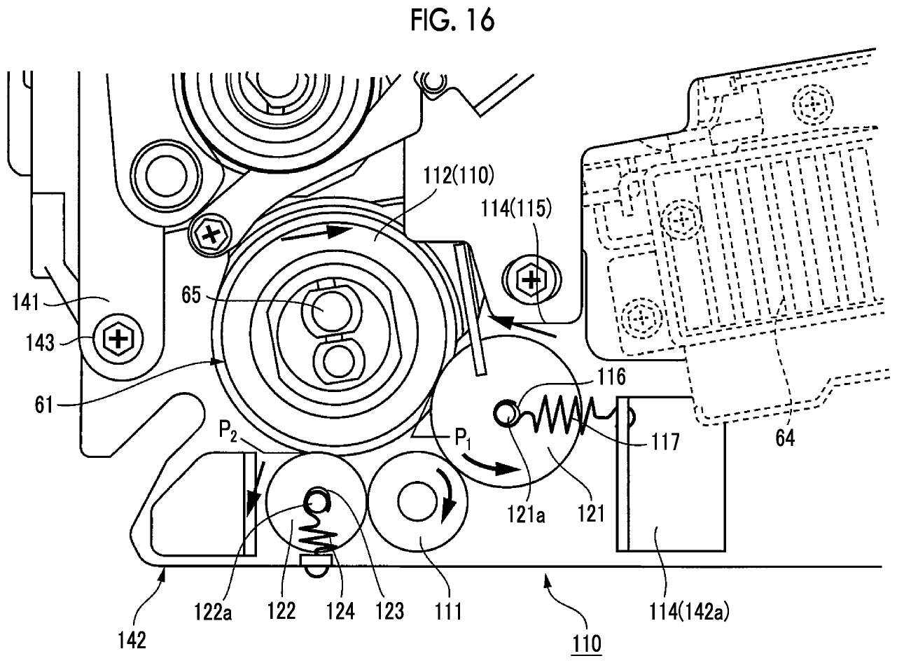

In a case where the heating fixing roller 61 is to be rotated in the normal rotation direction (clockwise in this example) in this example, the rotating operation handle 101 of the manual operation mechanism 100 may be rotated an appropriate number of times in a predetermined direction (clockwise in this example) as shown in FIG. 16. Since the first transmission gear 111 is rotated clockwise in this case, the first intermediate transmission gear 121 always meshing with the first transmission gear 111 is rotated counterclockwise. Then, a rotational operation force from the first transmission gear 111 is transmitted to the first intermediate transmission gear 121 at a meshing portion between the first transmission gear 111 and the first intermediate transmission gear 121. For this reason, the first intermediate transmission gear 121 is pushed toward the second transmission gear 112 against the biasing force of the bias spring 117, and meshes with the second transmission gear 112.

As the rotating operation handle 101 is rotated an appropriate number of times in a predetermined direction in this state, the rotational operation force is transmitted in an order of the first transmission gear 111, the first intermediate transmission gear 121, and the second transmission gear 112 of the operation force transmission mechanism 110. As a result, the heating fixing roller 61 is rotated in the normal rotation direction.

In a case where the heating fixing roller 61 is rotated in the normal rotation direction as described above, the transport fixing belt 62 is moved in the normal rotation direction (the transport direction of the medium S) with the rotation of the heating fixing roller 61 and the pressure fixing roller 63 is also rotated while following the heating fixing roller 61 as in the first exemplary embodiment. For this reason, the jammed medium S is transported while being sandwiched in the fixing region FA between the heating fixing roller 61 and the pressure fixing roller 63, and is transported along the transport fixing belt 62. Then, the medium S is forcibly discharged from the outlet of the second fixing unit 60.

Forced Discharge of Medium from Inlet Side of Second Fixing Unit

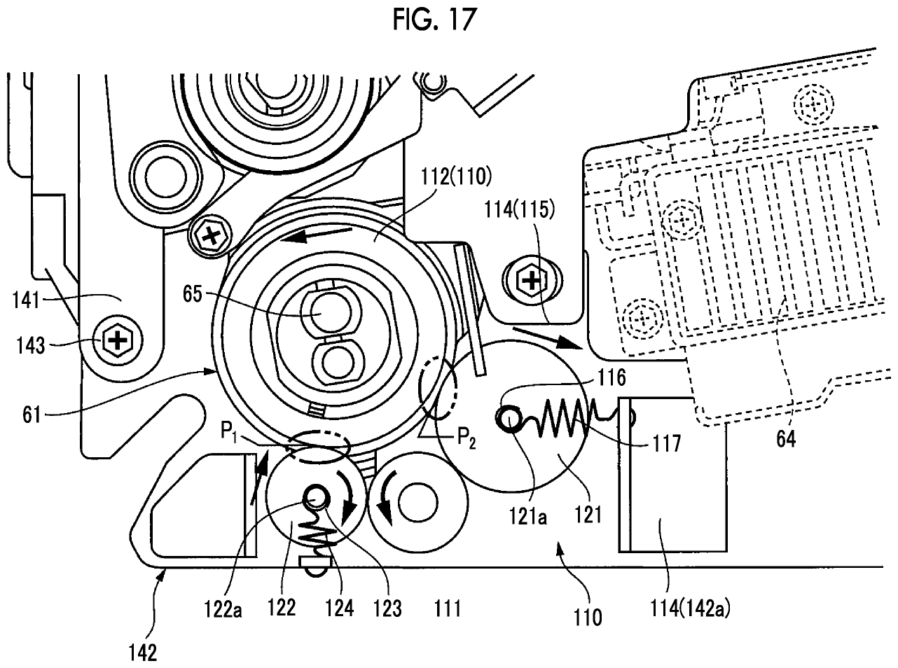

Next, in a case where the heating fixing roller 61 is to be rotated in the reverse rotation direction (counterclockwise in this example), the rotating operation handle 101 of the manual operation mechanism 100 may be rotated an appropriate number of times in a predetermined direction (counterclockwise in this example) as shown in FIG. 17. Since the first transmission gear 111 is rotated counterclockwise in this case, the second intermediate transmission gear 122 always meshing with the first transmission gear 111 is rotated clockwise. Then, a rotational operation force from the first transmission gear 111 is transmitted to the second intermediate transmission gear 122 at a meshing portion between the first transmission gear 111 and the second intermediate transmission gear 122. For this reason, the second intermediate transmission gear 122 is pushed toward the second transmission gear 112 against the biasing force of the bias spring 124, and meshes with the second transmission gear 112.

As the rotating operation handle 101 is rotated an appropriate number of times in a predetermined direction in this state, the rotational operation force is transmitted in an order of the first transmission gear 111, the second intermediate transmission gear 122, and the second transmission gear 112 of the operation force transmission mechanism 110. As a result, the heating fixing roller 61 is rotated in the reverse rotation direction (counterclockwise in this example).

In a case where the heating fixing roller 61 is rotated in the reverse rotation direction as described above, the transport fixing belt 62 is moved in the reverse rotation direction (a direction opposite to the transport direction of the medium S) with the rotation of the heating fixing roller 61 and the pressure fixing roller 63 is also rotated while following the heating fixing roller 61. For this reason, the jammed medium S is transported in the direction opposite to the transport direction of the medium S while being sandwiched in the fixing region FA between the heating fixing roller 61 and the pressure fixing roller 63, and is transported in the direction opposite to the transport direction of the medium S along the transport fixing belt 62. Then, the medium S is forcibly discharged from the inlet of the second fixing unit 60.

### Fourth Exemplary Embodiment

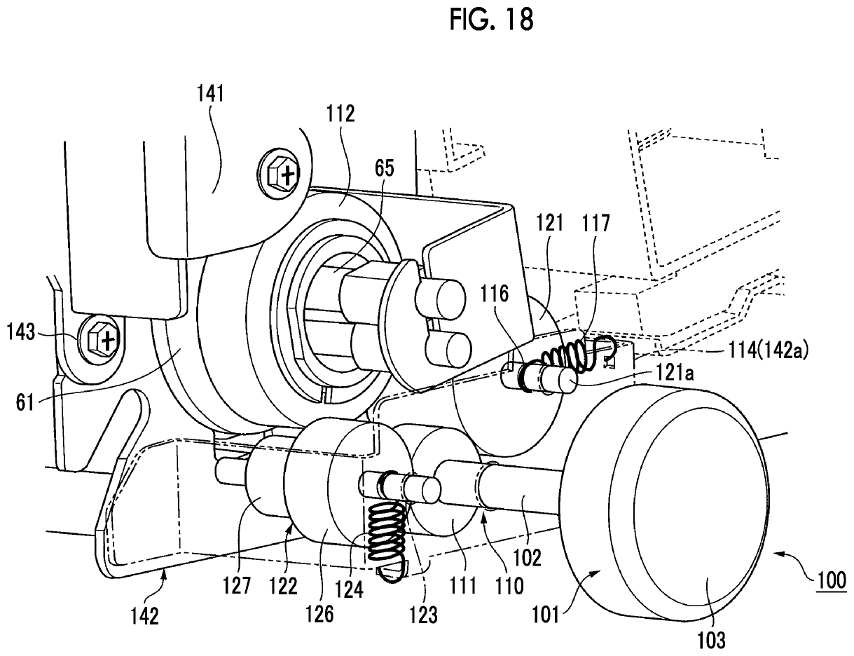

FIG. 18 is a perspective view showing major parts of a manual operation mechanism of a second fixing unit according to a fourth exemplary embodiment.

In FIG. 18, a basic configuration of the second fixing unit 60 is substantially identical to the basic configuration of the second fixing unit of the third exemplary embodiment, but a part of a configuration of an operation force transmission mechanism 110 of the manual operation mechanism 100 is different from a part of the configuration of the operation force transmission mechanism of the third exemplary embodiment. Meanwhile, components identical to the components of the third exemplary embodiment will be denoted by reference numerals identical to the reference numerals of the third exemplary embodiment, and detailed description thereof will be omitted here.

In this example, the operation force transmission mechanism 110 includes a first transmission gear 111, a second transmission gear 112, a first intermediate transmission gear 121, and a second intermediate transmission gear 122. Here, unlike in the third exemplary embodiment, the second intermediate transmission gear 122 has a multi-stage gear configuration that includes a front-stage gear 126 having a large diameter and a rear-stage gear 127 provided coaxially with the front-stage gear 126 and having a diameter smaller than the diameter of the front-stage gear 126. Further, the front-stage gear 126 having a large diameter meshes with the first transmission gear 111, and the rear-stage gear 127 having a small diameter is provided to be movable between a contact position P1 and a retreat position P2 with respect to the second transmission gear 112.

Accordingly, according to the present exemplary embodiment, a jam handling operation in the second fixing unit 60 is substantially identical to a jam handling operation in the second fixing unit of the third exemplary embodiment but is superior to the jam handling operation in the second fixing unit of the third exemplary embodiment in terms of the following points.

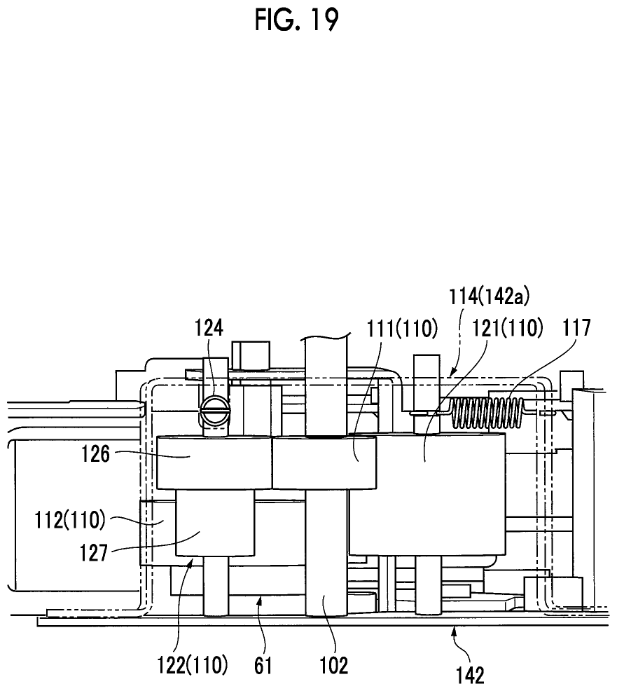

That is, in a case where the rotating operation handle 101 is rotated counterclockwise an appropriate number of times as shown in FIGS. 18 and 19 in order to forcibly discharge a jammed medium S from an inlet side of the second fixing unit 60 in this example, the first transmission gear 111 is rotated counterclockwise.

In this case, the front-stage gear 126, which has a large diameter, of the second intermediate transmission gear 122 always meshing with the first transmission gear 111 is rotated clockwise. Then, a rotational operation force from the first transmission gear 111 is transmitted to the second intermediate transmission gear 122 at a meshing portion between the first transmission gear 111 and the front-stage gear 126 having a large diameter. For this reason, the second intermediate transmission gear 122 is pushed toward the second transmission gear 112 against the biasing force of the bias spring 124, and the rear-stage gear 127 having a small diameter meshes with the second transmission gear 112.

As the rotating operation handle 101 is rotated counterclockwise an appropriate number of times in this state, the rotational operation force is transmitted in an order of the first transmission gear 111, the second intermediate transmission gear 122, and the second transmission gear 112 of the operation force transmission mechanism 110. As a result, the heating fixing roller 61 is rotated in the reverse rotation direction (counterclockwise in this example).

At this time, in a case where a gear diameter of the front-stage gear 126, which has a large diameter, of the second intermediate transmission gear 122 is denoted by Df and a gear diameter of the rear-stage gear 127 having a small diameter is denoted by Dr, a gear ratio (Dr/Df) is less than 1. Accordingly, the rotational speed of the heating fixing roller 61 can be reduced as compared to an aspect in which the second intermediate transmission gear 122 does not have a multi-stage configuration.

Therefore, in the present exemplary embodiment, even if the rotating operation handle 101 is unintentionally rotated counterclockwise at a high speed, the speed of the medium S forcibly discharged from the inlet of the second fixing unit 60 can be set to be low as much as the rotational speed of the heating fixing roller 61 can be reduced.

Further, in this example, the second intermediate transmission gear 122 having a multi-stage configuration can increase the rotational operation force of the rotating operation handle 101. For this reason, a force required for the rotational operation of the rotating operation handle 101 can be reduced. Accordingly, the transport fixing belt 62 can be moved with a small force, so that the jammed medium S can be forcibly discharged.

Meanwhile, the second intermediate transmission gear 122 has a multi-stage gear configuration in the present exemplary embodiment, but is not limited thereto. Even in a case where the first intermediate transmission gear 121 has a multi-stage gear configuration instead of or in addition to the second intermediate transmission gear 122 and the jammed medium S is to be forcibly discharged from the outlet of the second fixing unit 60, the transport speed of the jammed medium S may be reduced.

### Fifth Exemplary Embodiment

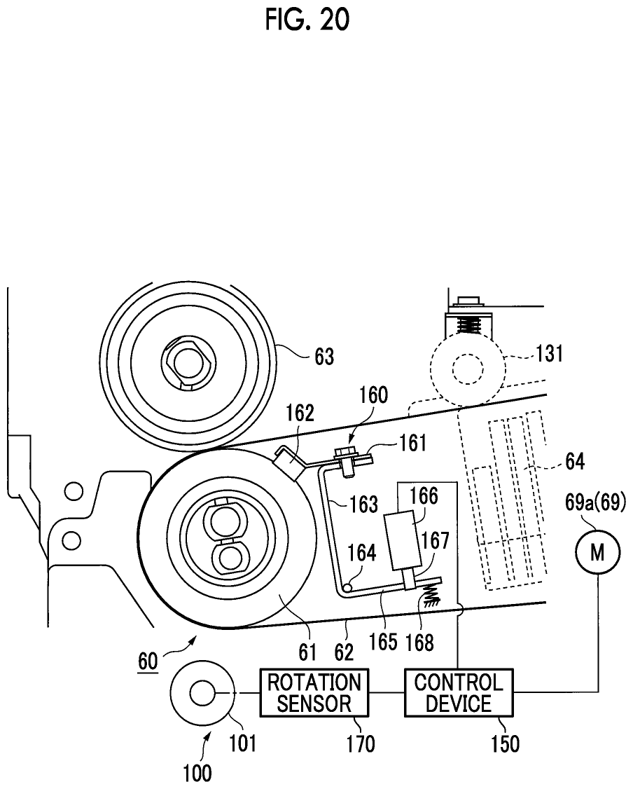

FIG. 20 is a diagram showing major parts of a manual operation mechanism of a second fixing unit according to a fifth exemplary embodiment.

In FIG. 20, a basic configuration of the second fixing unit 60 is substantially identical to the basic configuration of the second fixing unit of the second exemplary embodiment but the second fixing unit 60 includes a cleaner 160 that cleans the peripheral surface of the heating fixing roller 61.

Further, the basic configuration of the manual operation mechanism 100 is substantially identical to the basic configuration of the manual operation mechanism of the second exemplary embodiment. However, the manual operation mechanism 100 employs a configuration in which the cleaner 160 temporarily retreats from the heating fixing roller 61 in a case where a rotating operation handle 101 is rotationally operated. Meanwhile, components identical to the components of the second exemplary embodiment will be denoted by reference numerals identical to the reference numerals of the second exemplary embodiment, and detailed description thereof will be omitted here.

In the present exemplary embodiment, in the cleaner 160, a cleaning pad 162 is fixed to a distal end portion of a support arm 161 and a proximal end portion of the support arm 161 is fixed to an oscillation arm 163.

In this example, the oscillation arm 163 is to cause the cleaning pad 162 to oscillate between a contact position and a retreat position about an oscillation fulcrum 164. Further, an operation piece 165 extending in a radial direction is provided at the oscillation fulcrum 164 of the oscillation arm 163, and an operation rod 167 of an actuator 166, such as an electromagnetic solenoid, is connected to the operation piece 165 at a position away from the oscillation fulcrum 164. Furthermore, the operation piece 165 is provided with a bias spring 168 that biases the operation piece 165 to a side facing the advance direction of the operation rod 167 of the actuator 166.

Moreover, the manual operation mechanism 100 is provided with a rotation sensor 170 detecting that the rotating operation handle 101 is rotated.

In this example, the control device 150 is adapted to determine whether or not the heating fixing roller 61 is driven to rotate by the drive motor 69a and to determine whether or not the rotating operation handle 101 is rotated on the basis of detection information output from the rotation sensor 170.

In the present exemplary embodiment, in a case where the heating fixing roller 61 is driven to rotate by the drive motor 69a, the control device 150 turns off the actuator 166 to cause the oscillation arm 163 to oscillate to a predetermined position with a biasing force of the bias spring 168 and to cause the cleaning pad 162 of the cleaner 160 to be in contact with the heating fixing roller 61 with a predetermined contact pressure.

For this reason, in a case where the heating fixing roller 61 is driven to rotate, the cleaner 160 is in contact with the peripheral surface of the heating fixing roller 61 and cleans the peripheral surface of the heating fixing roller 61.

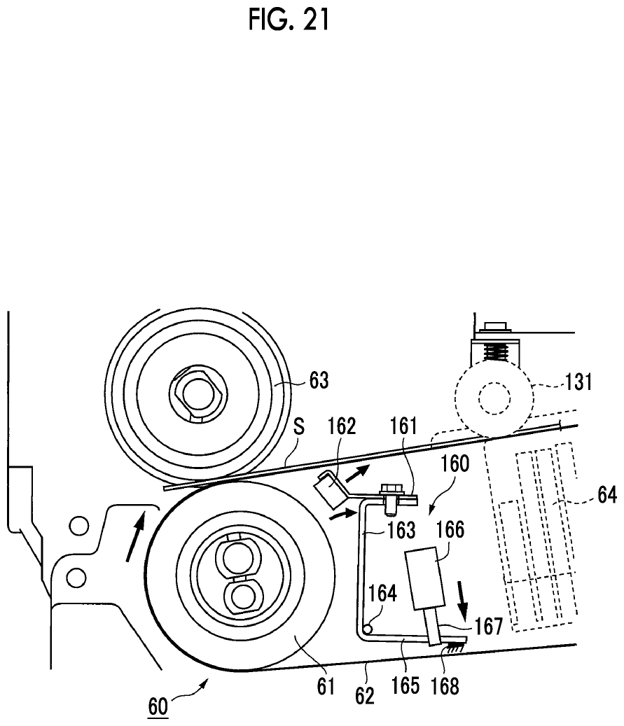

On the other hand, in a case where the drive motor 69a of the heating fixing roller 61 is stopped and the rotating operation handle 101 of the manual operation mechanism 100 is rotationally operated in this state, the rotation sensor 170 detects the rotational operation of the rotating operation handle 101 as shown in FIGS. 20 and 21. Then, the control device 150 turns on the actuator 166 and the operation rod 167 of the actuator 166 pushes the operation piece 165 of the oscillation arm 163 against the biasing force of the bias spring 168. As a result, the oscillation arm 163 oscillates clockwise and the cleaning pad 162 of the cleaner 160 retreats from the peripheral surface of the heating fixing roller 61.

For this reason, in the present exemplary embodiment, in a case where the rotating operation handle 101 of the manual operation mechanism 100 is rotationally operated in a condition in which the heating fixing roller 61 is not driven to rotate, the heating fixing roller 61 can be manually rotated in a state where the cleaner 160 retreats from the heating fixing roller 61.

Further, in the present exemplary embodiment, a case where the heating fixing roller 61 is rotated in the normal rotation direction (corresponding to the transport direction of a medium) is assumed and the cleaner 160 is disposed in contact with the heating fixing roller 61 with a predetermined posture.

For this reason, for example, in a case where the heating fixing roller 61 is rotated in the reverse rotation direction, there is a concern that a situation in which the cleaning pad 162 of the cleaner 160 turns over with the reverse rotation of the heating fixing roller 61 occurs. In a case where the heating fixing roller 61 is driven to rotate in the reverse rotation direction under such a situation, the cleaner 160 may be caused to retreat from the peripheral surface of the heating fixing roller 61.

### Supplementary Note

(((1)))

A fixing device that heats and pressurizes a medium on which an unfixed image is held to fix the unfixed image, the fixing device comprising:
a heating fixing part that includes a heating source;
a belt-like transport fixing part that is stretched and rotatably provided around the heating fixing part and is in contact with an image surface of the medium to transport the medium;
a pressure fixing part that is disposed to face the heating fixing part with the transport fixing part interposed therebetween and is pressurized to form a fixing region between the heating fixing part and the pressure fixing part;
a drive unit that drives the transport fixing part to rotate the transport fixing part with a driving force generated from a drive source; and
an operation unit that is operated to manually rotate the transport fixing part in a state where the drive unit is not used.

(((2)))

The fixing device according to (((1))),
wherein the operation unit includes a rotating operation member that is used to manually rotate the heating fixing part in a case where the drive unit is not used.

(((3))

The fixing device according to (((2))),
wherein the operation unit includes the rotating operation member that includes a rotating shaft deviated from a rotating shaft of the heating fixing part, and an operation force transmission unit that is provided between the rotating operation member and the heating fixing part and transmits a rotational operation force from the rotating operation member to the heating fixing part.

(((4)))

The fixing device according to any one of (((1))) to (((3))), further comprising:
a support unit that includes a first support member supporting the pressure fixing part and a second support member supporting the heating fixing part and the transport fixing part and in which the first support member is provided to be oscillatable about an oscillation fulcrum relative to the second support member,
wherein the operation unit is held on a side of the second support member to be manually rotatable.

((5)

The fixing device according to (((4))),
wherein the operation unit includes a rotating operation member that is disposed on a side of the second support member opposite to the oscillation fulcrum with the heating fixing part interposed therebetween, and an operation force transmission unit that is provided between the rotating operation member and the heating fixing part, transmits a rotational operation force of the rotating operation member to the heating fixing part, and rotates the heating fixing part in a direction in which the heating fixing part is pressed against a side of the pressure fixing part.

(((6))

The fixing device according to any one of (((1))) to
wherein the operation unit includes a rotating operation member that rotates the transport fixing part in a predetermined direction or both normal and reverse directions in a case where the drive unit is not used.

(((7)))

The fixing device according to (((6))),
wherein the operation unit includes an operation force transmission unit that stops rotation of the rotating operation member in a case where the transport fixing part is rotated by the drive unit and transmits a rotational operation force of the rotating operation member to the transport fixing part in a case where the drive unit is not used.

(8)

The fixing device according to (((7))
wherein the operation force transmission unit includes a movable transmission member that is moved to a transmission position from a retreat position while following a rotational operation of the rotating operation member, and a biasing member that biases the movable transmission member to hold the movable transmission member at the retreat position in a case where the rotating operation member is being stopping.

(((9)))

The fixing device according to any one of (((1))) to (((8))),
wherein the operation unit includes a rotating operation member that rotates the transport fixing part in a case where the drive unit is not used, and an operation force transmission unit that transmits a rotational operation force from the rotating operation member to the transport fixing part to rotate the transport fixing part, and
the operation force transmission unit includes a reduction element that reduces a rotational speed of the transport fixing part with respect to a rotational speed of the rotating operation member.

(((10)))

The fixing device according to (((9))),
wherein the reduction element rotates the transport fixing part with a rotational force larger than the rotational operation force of the rotating operation member.

(11)

The fixing device according to any one of (((1))) to (10))),
wherein the operation unit includes a rotating operation member that rotates the transport fixing part in a case where the drive unit is not used, an operation force transmission unit that transmits a rotational operation force from the rotating operation member to the transport fixing part to rotate the transport fixing part, and a support unit that supports the rotating operation member and the operation force transmission unit, and
the support unit includes a cover member covering the operation force transmission unit.

(((12)))

The fixing device according to any one of (((1))) to (11))), further comprising:
a cleaning unit that is disposed in contact with a peripheral surface of the heating fixing part and cleans the peripheral surface of the heating fixing part,
wherein the operation unit includes a rotating operation member that rotates the heating fixing part in a case where the drive unit is not used, and a retreat unit that causes the cleaning unit to retreat from the peripheral surface of the heating fixing part in conjunction with rotation of the rotating operation member.

(((13)))

The fixing device according to any one of (((1))) to (((12))), further comprising:
a cooling unit that is provided in contact with a back of a medium transport region of the transport fixing part at a portion of the transport fixing part on a downstream side of the fixing region in a transport direction of the medium and cools the transport fixing part.

(((14)))

An image forming system comprising:
an imaging device that generates an unfixed image on a medium; and
the fixing device according to any one of (((1))) to (((13))) that fixes the unfixed image held on the medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device that heats and pressurizes a medium on which an unfixed image is held to fix the unfixed image, the fixing device comprising:
a heating fixing part that includes a heating source;
a belt-like transport fixing part that is stretched and rotatably provided around the heating fixing part and is in contact with an image surface of the medium to transport the medium;
a pressure fixing part that is disposed to face the heating fixing part with the transport fixing part interposed therebetween and is pressurized to form a fixing region between the heating fixing part and the pressure fixing part;
a drive unit that drives the transport fixing part to rotate the transport fixing part with a driving force generated from a drive source; and
an operation unit that is operated to manually rotate the transport fixing part in a state where the drive unit is not used.

2. The fixing device according to claim 1,
wherein the operation unit includes a rotating operation member that is used to manually rotate the heating fixing part in a case where the drive unit is not used.

3. The fixing device according to claim 2,
wherein the operation unit includes the rotating operation member that includes a rotating shaft deviated from a rotating shaft of the heating fixing part, and an operation force transmission unit that is provided between the rotating operation member and the heating fixing part and transmits a rotational operation force from the rotating operation member to the heating fixing part.

4. The fixing device according to claim 1, further comprising:
a support unit that includes a first support member supporting the pressure fixing part and a second support member supporting the heating fixing part and the transport fixing part and in which the first support member is provided to be oscillatable about an oscillation fulcrum relative to the second support member,
wherein the operation unit is held on a side of the second support member to be manually rotatable.

5. The fixing device according to claim 4,
wherein the operation unit includes a rotating operation member that is disposed on a side of the second support member opposite to the oscillation fulcrum with the heating fixing part interposed therebetween, and an operation force transmission unit that is provided between the rotating operation member and the heating fixing part, transmits a rotational operation force of the rotating operation member to the heating fixing part, and rotates the heating fixing part in a direction in which the heating fixing part is pressed against a side of the pressure fixing part.

6. The fixing device according to claim 1,
wherein the operation unit includes a rotating operation member that rotates the transport fixing part in a predetermined direction or both normal and reverse directions in a case where the drive unit is not used.

7. The fixing device according to claim 6,
wherein the operation unit includes an operation force transmission unit that stops rotation of the rotating operation member in a case where the transport fixing part is rotated by the drive unit and transmits a rotational operation force of the rotating operation member to the transport fixing part in a case where the drive unit is not used.

8. The fixing device according to claim 7,
wherein the operation force transmission unit includes a movable transmission member that is moved to a transmission position from a retreat position while following a rotational operation of the rotating operation member, and a biasing member that biases the movable transmission member to hold the movable transmission member at the retreat position in a case where the rotating operation member is being stopping.

9. The fixing device according to claim 1,
wherein the operation unit includes a rotating operation member that rotates the transport fixing part in a case where the drive unit is not used, and an operation force transmission unit that transmits a rotational operation force from the rotating operation member to the transport fixing part to rotate the transport fixing part, and
the operation force transmission unit includes a reduction element that reduces a rotational speed of the transport fixing part with respect to a rotational speed of the rotating operation member.

10. The fixing device according to claim 9,
wherein the reduction element rotates the transport fixing part with a rotational force larger than the rotational operation force of the rotating operation member.

11. The fixing device according to claim 1,
wherein the operation unit includes a rotating operation member that rotates the transport fixing part in a case where the drive unit is not used, an operation force transmission unit that transmits a rotational operation force from the rotating operation member to the transport fixing part to rotate the transport fixing part, and a support unit that supports the rotating operation member and the operation force transmission unit, and
the support unit includes a cover member covering the operation force transmission unit.

12. The fixing device according to claim 1, further comprising:
a cleaning unit that is disposed in contact with a peripheral surface of the heating fixing part and cleans the peripheral surface of the heating fixing part,
wherein the operation unit includes a rotating operation member that rotates the heating fixing part in a case where the drive unit is not used, and a retreat unit that causes the cleaning unit to retreat from the peripheral surface of the heating fixing part in conjunction with rotation of the rotating operation member.

13. The fixing device according to claim 1, further comprising:
a cooling unit that is provided in contact with a back of a medium transport region of the transport fixing part at a portion of the transport fixing part on a downstream side of the fixing region in a transport direction of the medium and cools the transport fixing part.

14. An image forming system comprising:
an imaging device that generates an unfixed image on a medium; and
the fixing device according to claim 1 that fixes the unfixed image held on the medium.

15. An image forming system comprising:
an imaging device that generates an unfixed image on a medium; and
the fixing device according to claim 2 that fixes the unfixed image held on the medium.

16. An image forming system comprising:
an imaging device that generates an unfixed image on a medium; and
the fixing device according to claim 3 that fixes the unfixed image held on the medium.

17. An image forming system comprising:
an imaging device that generates an unfixed image on a medium; and
the fixing device according to claim 4 that fixes the unfixed image held on the medium.

18. An image forming system comprising:
an imaging device that generates an unfixed image on a medium; and
the fixing device according to claim 5 that fixes the unfixed image held on the medium.

19. An image forming system comprising:
an imaging device that generates an unfixed image on a medium; and
the fixing device according to claim 6 that fixes the unfixed image held on the medium.

20. An image forming system comprising:
an imaging device that generates an unfixed image on a medium; and
the fixing device according to claim 7 that fixes the unfixed image held on the medium.
